(19) United States
(12) Patent Application Publication
(10) Pub. No.: US 2023/0073151 A1
(43) Pub. Date: Mar. 9, 2023

(54) EARLY DETECTION OF ABNORMAL DRIVING BEHAVIOR

(71) Applicant: Toyota Motor Engineering & Manufacturing North America, Inc., Plano, TX (US)

(72) Inventors: Seyhan Ucar, Mountain View, CA (US); Kentaro Oguchi, Mountain View, CA (US)

(21) Appl. No.: 17/471,057

(22) Filed: Sep. 9, 2021

(51) Int. Cl. G01S 19/26; B60W 50/14; G08G 1/16

(52) U.S. Cl. CPC G01S 19/26; B60W 50/14; G08G 1/167; B60W 2520/105; B60W 2556/10; B60W 2422/95; B60W 2556/65

(57) ABSTRACT

The disclosure includes embodiments for early detection of abnormal driving behavior. A method according to some embodiments includes sensing, by a sensor set of an ego vehicle, a remote vehicle to generate sensor data describing driving behavior of the remote vehicle. The method includes comparing the sensor data to a set of criteria for abnormal driving behavior. The method includes determining that a subset of the set of criteria are described by the sensor data. The subset satisfies a threshold for early detection of abnormal driving behavior. For example, detecting the subset triggers the determination that abnormal driving behavior is detected. The method includes determining that the remote vehicle is engaged in abnormal driving behavior based on satisfaction of threshold. In some embodiments, an abnormal driving behavior is one which satisfies a threshold for abnormality or matches a pattern of an identified abnormal driving behavior.

### BACKGROUND

The specification relates to early detection of abnormal driving behavior by an onboard vehicle computer of a connected vehicle.

Drivers of vehicles sometimes drive abnormally for various reasons. For example, the driver may be experiencing from one or more of the following conditions which contributes to their driving their vehicle abnormally: fatigue; poor vision; driving in inclement weather; driving at night; distraction; alcohol consumption; drug use; inexperience; diminished capacity; medical treatment; medical condition; any condition that is related to, or a derivative of, the conditions previously listed; etc.

Sometimes a vehicle is driven abnormally because it needs repair or maintenance. For example, the vehicle may have one or more of the following conditions: a flat tire; incorrect air pressure in a tire; a broken or uncalibrated sensor; low fluid; a fluid leak; a fault with the vehicle breaking system; a fault with the vehicle fuel injection system; a fault with the vehicle power steering system; a fault with a vehicle control system; a fault with a vehicle computer or sensor; a fault with the vehicle electrical system; a loose belt or chain; damage to a body panel or some other portion of the vehicle; an onboard vehicle computer that needs a software update; or any other condition or combination of conditions which adversely affects the operation of the vehicle and is capable of correction by repair of one or more vehicle parts, replacement of one or more vehicle parts, or maintenance to one or more vehicle parts.

Modern vehicles broadcast vehicle-to-everything (V2X) messages that include digital data describing their locations, speeds, headings, past actions, and future actions, etc. Vehicles that broadcast V2X messages are referred to as “V2X transmitters.” Vehicles that receive the V2X messages are referred to as “V2X receivers.” The digital data that is included in the V2X messages can be used for various purposes including, for example, the proper operation of Advanced Driver Assistance Systems (ADAS systems) or autonomous driving systems which are included in the V2X receivers.

Modern vehicles include ADAS systems or automated driving systems. An automated driving system is a collection of ADAS systems which provides sufficient driver assistance that a vehicle is autonomous. ADAS systems and automated driving systems are referred to as “vehicle control systems.” Other types of vehicle control systems are possible. A vehicle control system includes code and routines, and optionally hardware, that are operable to control the operation of some or all of the systems of a vehicle.

A particular vehicle that includes these vehicle applications is referred to herein as an “ego vehicle” and other vehicles in the vicinity of the ego vehicle are referred to as “remote vehicles.”

### SUMMARY

Described herein are embodiments of a detection system. See, for example, the detection system illustrated in FIGS. 1 and 2.

A problem is that some of the vehicles that operate on the roadways display abnormal driving behavior. Existing solutions to this problem focus on detecting abnormal driving behavior and initiating management systems that attempt to minimize the risk caused by the abnormal driving behavior by addressing the harm or risk caused by the abnormal driving behavior; this focus on addressing the harm or risk caused by the abnormal driving behavior is the critical focus of these existing solutions. For example, if a vehicle is swerving outside of their lane of travel, the existing solutions temporarily take control of the steering of the vehicle and recenter the vehicle inside its own lane of travel. Some existing solutions do not take control of the vehicle which is being driven abnormally, and instead provide a notification of the abnormal driving to the driver of the vehicle which may or may not be accompanied by a suggestion for how to correct the problem. Some existing solutions use cellular communications to notify other vehicles about the abnormal driving behavior.

What is needed is an approach that detects abnormal driving behavior by a remote vehicle as early as possible so that ego vehicles can take remedial action as early as possible in order to avoid the risk posed by the remote vehicle. Abnormal driving behavior by a remote vehicle may be propagated to other nearby vehicles thereby amplifying the amount of abnormal driving behavior on the roadway. Drivers that are not driving abnormally can inherit abnormal driving behavior from other drivers as they come in the vicinity of remote vehicles that are demonstrating abnormal driving behavior. For example, if a remote vehicle is changing lanes and cutting off other remote vehicles (e.g., an example of aggressive driving, which is one example type of abnormal driving behavior), then the other remote vehicles that are cut off my unexpectedly hard brake in order to avoid a collision (e.g., another example of aggressive driving). Accidents can be reduced if ego vehicles detect the earliest instance of abnormal driving behavior and take mitigating steps (e.g., a remedial action plan) to avoid being affected by the abnormal driving behavior.

Accordingly, the ability of an ego vehicle to detect abnormal driving behavior by an ego driver earlier allows the driver of the ego vehicles to take mitigating steps to avoid being affected by the abnormally driving vehicles within the vicinity of the ego vehicle is beneficial and improves the overall operation of the ego vehicle and increases roadway safety. The detection system described herein provides this benefit, among others. For example, early detection of abnormal driving behavior by the detection system described herein is beneficial because it helps the detection system to notify the driver of the ego vehicle about the presence of the abnormal driving behavior and/or assist the driver in managing the abnormal driving behavior. If the abnormal driving behavior is detected earlier, then the detection system has more options for how to manage the abnormal driving behavior (e.g., the options become fewer as a collision or other incident become more imminent) and the driver of the ego vehicle (or the ADAS systems of the ego vehicle) have more time to implement the remedial action(s) which achieve the management of the abnormal driving behavior. In some embodiments, earlier detection of the abnormal driving behavior also decreases the likelihood that the abnormal driving behavior is propagated to the ego vehicle itself and/or other vehicles on the roadway that are not demonstrating abnormal driving behavior.

Remedial action plan data includes digital data that describes a strategy for how a driver or group of drivers (e.g., coordinated as a vehicular micro cloud) are recommended by the detection system to respond to the occurrence of an abnormal driving behavior or a combination of abnormal driving behaviors as detected by the detection system. In some embodiments, a remedial action plan includes a set of remedial actions whose execution achieve management of an identified abnormal driving behavior or combination of abnormal driving behaviors. In some embodiments, the detection system tailors a remedial action plan to specifically address a particular type of abnormal driving behavior or combination of abnormal driving behaviors. An example of the remedial action plan data according to some embodiments includes the remedial action plan data 182 depicted in FIG. 1.

In some embodiments, the remedial action plan selected or generated by the detection system is generated to account for variables such as one or more of the following: which combination abnormal driving behaviors are identified by the detection system; weather conditions; lighting conditions; road-surface conditions (e.g., wet or icy conditions); roadway congestion (e.g., number of vehicles per unit of measurement such as feet or meters); and road geometry conditions.

The detection system includes code and routines that are stored on a non-transitory memory. In some embodiments, the code and routines of the detection system are configured, when executed by a processor (e.g., a processor of an onboard vehicle computer of an ego vehicle), to cause the processor to execute one or more of the steps depicted in methods 300 and 400 of FIG. 3 and FIGS. 4A and 4B, respectively.

Abnormal Driving Behavior

In some embodiments, the processor that executes the detection system has access to criteria data. In some embodiments, the criteria data is organized in a data structure such as a database. An example of the data structure includes, according to some embodiments, the data structure 131 depicted in FIG. 1. The criteria data includes digital data that describes a plurality of abnormal driving behaviors. An abnormal driving behavior is a driving behavior that satisfies a set of criteria. The set of criteria include one or more criteria. Accordingly, an abnormal driving behavior includes any driving behavior by a vehicle that satisfies a set of criteria described by the criteria data. An example of the criteria data includes, according to some embodiments, the criteria data 132 depicted in FIG. 1.

The criteria data includes digital data that describes: (1) a plurality of abnormal driving behaviors; and (2) for individual abnormal driving behaviors, the set of criteria whose occurrence indicates that the abnormal driving behavior is present in a roadway environment. In some embodiments, the abnormal driving behaviors are defined by a human (e.g., an engineer or programmer) that has access to program the criteria data into the data structure. In some embodiments, the set of criteria whose occurrence indicates that the abnormal driving behavior is present in a roadway environment are defined by the human.

In some embodiments, the abnormal driving behaviors are inputted by the human from a known set of abnormal driving behaviors and the detection system analyses sensor data measurements of the real-world and/or digital twin simulations to determine the set of criteria whose occurrence corresponds to the occurrence of the abnormal driving behavior.

In some embodiments, the abnormal driving behaviors include one or more of those described in the following publications: “National Mother Vehicle Crash Causation Survey Report to Congress,” Publication No. DOT HS 811 059, Published in 2008 by the National Technical Information Service, Springfield, Va. 22161; “Analysis of SHRP2 Data to Understand Normal and Abnormal Driving Behavior in Work Zones,” Publication No. FHWA-HRT-20-010, Published December 2019 by the U.S. Department of Transportation Federal Highway Administration, McLean, Va. 22101; Hankey et. al., “Description of the SHRP 2 Naturalistic Database and the Crash, Near-crash, and Baseline Data Sets Task Report,” Published April 2016 by Virginia Tech Transportation Institute, Blacksburg, Va.; and the SHRP 2 Naturalistic Driving Study (NDS) database maintained by the Virginia Tech Transportation Institute, Blacksburg, Va. and retrieved from insight.shrp2nds.us on Aug. 24, 2021.

In some embodiments, the detection system includes one or more machine learning algorithms that modifies and/or improves the set of criteria over time based on real-world observations it makes regarding what events occurring in the real-world correlate to the occurrence of a particular abnormal driving behavior in the real-world as determined by the machine learning algorithms. In some embodiments, the detection system includes one or more machine learning algorithms and one or more digital twin simulation software programs that modifies and/or improves the set of criteria over time based on the execution of one or more digital twin simulations and what events occurring in the digital twin simulations correlate to the occurrence of a particular abnormal driving behavior in the digital twin simulations as determined by the machine learning algorithms.

In some embodiments, the detection system includes one or more algorithms that are operable to execute a time series analysis and/or pattern recognition analysis using sensor data, or any other digital data or combination of digital data described herein as an input, and output modifications or improvements to the set of criteria data over time. For example, the detection system modifies and/or improves the set of criteria over time based on inferences or interpolation based on one or more of pattern recognition and time series analysis executed against the digital data inputted to the algorithms of the detection system. The detection system includes code and routines and any digital data necessary to execute the pattern recognition analysis and/or the time series analysis. In some embodiments, sensor data is collected by the sensor set of the ego vehicle, and it is analyzed by the algorithms of the detection system to determine the most repeating and/or most contrasting driving behavior and this is used to modify and/or improve the set of criteria.

In some embodiments, the abnormal driving behaviors and the corresponding set of criteria are learned by the detection system over time as the detection system is executed. For example, the detection system includes one or more machine learning algorithms that studies sensor data recorded by the sensor sets of the ego vehicle and/or one or more remote vehicles and the machine learning algorithms are configured to generate criteria data describing observed abnormal driving behaviors and the set of criteria that correspond to the occurrence of these abnormal driving behaviors; the machine learning algorithms then output the criteria data which is then organized in the data structure by the detection system.

In some embodiments, an abnormal driving behavior is a driving behavior that satisfies a threshold of risk for a collision or some other undesirable roadway event (e.g., hard braking, rubbernecking, any other undesirable roadway event or behavior, etc.). Examples of undesirable roadway events or behaviors include, in some embodiments, those described in the National Mother Vehicle Crash Causation Survey Report to Congress (DOT HS 811 059) published in 2008 by the National Technical Information Service, Springfield, Va. 22161. Threshold data includes digital data that describes any threshold described herein. An example of the threshold data includes, according to some embodiments, the threshold data 196 depicted in FIG. 1.

Early Detection

An abnormal driving behavior is defined as the occurrence of a set of criteria. As used herein, an “early” detection of an abnormal driving behavior means that the detection system determines the occurrence of an abnormal driving behavior based on detecting a subset of the set of criteria for that abnormal driving behavior.

For example, in some embodiments a type of abnormal driving behavior includes an aggressive driver as defined by the occurrence of the following criteria: (1) many attempts by a remote vehicle to pass a preceding vehicle (e.g., lane change to the left, followed by another lane change to the right, or vice versa, with the goal of passing the same vehicle); (2) traffic congestion; (3) the remote vehicle periodically or consistently experiencing periods of acceleration that exceeds the average acceleration of the other vehicles nearby the remote vehicle (or, alternatively, an acceleration that satisfies a threshold for acceleration as described by the threshold data); and (4) the remote vehicle periodically or consistently experiencing periods of velocity that exceeds the average velocity of the other vehicles nearby the remote vehicle (or, alternatively, an acceleration that satisfies a threshold for acceleration as described by the threshold data). Early detection of this type of abnormal driving behavior occurs if the detection system determines that abnormal driving behavior of this this is occurring based on detecting a subset of the total criteria for this type of abnormal driving behavior.

For example, the detection system analyzes the ego sensor data recorded by the sensor set of an ego vehicle that includes the detection system and based on this analysis the detection system identifies that a particular remote vehicle has had many attempts to pass a vehicle preceding the remote vehicle (e.g., driving ahead of the remote vehicle). In some embodiments, the detection system determines that an abnormal driving behavior is occurring based on identifying the occurrence of this one criteria. This is an example of early detection since the detection system determines that abnormal driving behavior is occurring based on identifying the occurrence of a subset of the total available criteria for this type of abnormal driving behavior.

As used herein, the term “many attempts” means a number of attempts N that satisfies a threshold that is described by the threshold data, where “N” is a positive whole number. Similarly, the term “traffic congestion” means a density of vehicles on a roadway (e.g., vehicles per square foot), or within a portion of the roadway, that satisfies a threshold that is described by the threshold data. Similarly, any potentially ambiguous term described herein is definable by reference to a satisfaction of a threshold.

The example of the aggressive driver type of abnormal driving behavior is an example of an “unordered set of criteria” since the abnormal driving behavior is occurring regardless of the order in which the criteria occur. In some embodiments, the set of criteria have to occur in a particular order or predetermined period of time. This is referred to as an “ordered set of criteria.” For example, a type of abnormal driving behavior includes a distracted driver as defined by the occurrence of one or more of the following: (1) (a) a long distance to collision between a remote vehicle and a preceding vehicle (e.g., a vehicle traveling in front of the remote vehicle) (b) followed by a short distance to collision between these two vehicles; and (2) (a) a short distance to collision between a remote vehicle and a preceding vehicle (b) followed by a long distance to collision between these two vehicles. In this example, the two criteria (e.g., the long distance to collision followed by the short distance to collision, or vice versa) must occur in the prescribed order within a predetermined period of time.

In some embodiments, the detection system beneficially determines the occurrence of an abnormal driving behavior when a subset of the criteria for an ordered set of criteria are determined to have occurred by the detection system. For example, in some embodiments the detection system determines that abnormal driving behavior is occurring based on detecting a short distance to collision between a remote vehicle and a vehicle preceding the remote vehicle (e.g., the vehicle traveling in front of the remote vehicle).

Described herein are embodiments of a detection system. In some embodiments, the detection system described herein beneficially includes code and routines that are operable, when executed by a processor, to cause the processor to analyze sensor data to determine abnormal driving behaviors and the criteria that indicate that these abnormal driving behaviors are occurring at a particular time. In some embodiments, the detection system uses a machine learning algorithm and/or a digital twin simulation software in order to determine abnormal driving behaviors and the criteria that indicate that these abnormal driving behaviors are occurring.

In some embodiments, the detection system includes code and routines that are operable, when executed by a processor, to cause the processor to execute one or more of the following steps: (1) identify a set of abnormal driving behavior types; (2) analyze one or more historical sets of ego sensor data and remote sensor data to determine a set of criteria for each of the abnormal driving behavior types; (3) for each abnormal behavior case, build an instance of criteria data describing the abnormal driving behavior cases and the set of criteria whose occurrence indicates the occurrence of the abnormal driving behavior type; (4) monitor real-time ego sensor data and/or remote sensor data to determine if any criteria are present for any abnormal driving types; (5) provide early identification of an abnormal driving behavior type based on the occurrence of a subset of the set of criteria for the abnormal driving behavior type which is identified early by the detection system; (6) take steps to inform the driver of the ego vehicle about the abnormal driving behavior type which is identified by the detecting system as occurring; and (7) take steps to inform the driver of one or more innocent remote vehicles about the abnormal driving behavior type which is identified by the detecting system as occurring. An innocent remote vehicle is one that is not being operated in a manner consistent with an abnormal driving behavior type.

Analysis data includes digital data that describes the output of any analysis, determination, identification, comparison, or process described herein. For example, with reference to method 300 depicted in FIG. 3, steps 310, 315, and 320 include comparisons and determinations, the output of which is described by analysis data that is outputted by the detection system. An example of the analysis data according to some embodiments includes the analysis data 181 depicted in FIG. 1.

In some embodiments, the method includes execution of a remedial action plan. In some embodiments, the remedial action plans implemented by the detection system are required to be pre-approved by a human prior to their implementation by the detection system. For example, in some embodiments the remedial action plans are pre-approved by the driver of the vehicle prior to their implementation (e.g., so that their implementation does not frighten, anger, confuse, surprise, or otherwise affect the driver in an unexpected way). In some embodiments, the remedial action plans are pre-approved by an engineer that designed the detection system. In some embodiments, the remedial action plans are pre-approved by the both the driver and the engineer.

In some embodiments, the remedial action plans are selected from a dataset of approved strategies that are designed by the engineer to counteract a known set of abnormal driving behaviors. In this way the remedial action plans are known to be effective at eliminating the abnormal driving behavior. In some embodiments, the remedial action plans are determined based at least in part on the execution of one or more digital twin simulations. Digital twin simulations are described in more detail below.

Digital twin data includes any digital data, software, and/or other information that is necessary to execute the digital twin simulations. An example of the digital twin data according to some embodiments includes the digital twin data 162 depicted in FIG. 1.

Examples of the embodiments are now described. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method executed by an onboard vehicle computer of an ego vehicle. The method also includes one or more of the following: sensing, by a sensor set of the ego vehicle, a remote vehicle to generate sensor data describing driving behavior of the remote vehicle; comparing the sensor data to a set of criteria for abnormal driving behavior; determining that a subset of the set of criteria are described by the sensor data, where the subset satisfy a threshold for early detection of abnormal driving behavior; and determining that the remote vehicle is engaged in abnormal driving behavior based on satisfaction of threshold. Other embodiments of this aspect include corresponding computer systems, apparatus, and computer programs recorded on one or more computer storage devices, each configured to perform the actions of the methods.

Implementations may include one or more of the following features. The method where the subset does not include all of the criteria included in the set of criteria. The method where each of the set of criteria are required to be described by the sensor data to avoid false positive detection of abnormal driving behavior and the onboard vehicle computer is configured to determine that the remote vehicle is engaged in abnormal driving behavior responsive to the subset being described by the sensor data so that early detection of abnormal driving behavior is achieved. The method where the early detection of abnormal driving behavior includes a risk of false positive detection. The method may include executing a remedial action responsive to the abnormal driving behavior. The method may include a feedback loop that includes continuing to sense the remote vehicle and determining if the remote vehicle is actually engaged in abnormal driving behavior. Continuing to sense the remote vehicle includes one or more sensors of the sensor set of the ego vehicle tracking the remote vehicle and continuing to record sensor measurements of the remote vehicle for a period of time. The method may include determining that the remote vehicle was not engaged in abnormal driving behavior and updating a criteria database with digital data that is configured to reduce a risk of a similar future false positive. The method may include receiving a wireless message including digital data describing that the remote vehicle is not engaged in abnormal driving behavior and reversing the determination that the remote vehicle is engaged in abnormal driving behavior. The method where the abnormal driving behavior is identified based at least in part on the execution of a set of digital twin simulations. The method where at least one step in the method is executed by onboard vehicle computers of one or more vehicles that are members of a vehicular micro cloud. The method where the abnormal driving behavior includes a distracted driver behavior, and the set of criteria include one or more of the following: (1) a large distance to collision at a first time t₁ followed by a short distance to collision at a second time t₂ that occurs after the first time; and (2) the short distance to collision at the first time t₁ followed by the short distance to collision at the second time t₂ that occurs after the first time. The method where the method determines that the remote vehicle is engaged in abnormal driving behavior based on the sensor data describing that the remote vehicle is driving with the large distance to collision and not the short distance to collision. The method where the abnormal driving behavior includes an aggressive driver behavior, and the set of criteria include (1) multiple attempts to pass a same vehicle, (2) lane cutting, and (3) high speed which satisfies a threshold for speed. The method where the method determines that the remote vehicle is engaged in abnormal driving behavior based on the sensor data describing that the remote vehicle is driving with any two of the set of criteria. The method where the subset of criteria is included in an ordered list and the method only determines that the remote vehicle is engaged in abnormal driving behavior if the criteria included in the subset are sensed by the sensor set occurring in the order of the list. The method where the subset of criteria is included in a list and the method determines that the remote vehicle is engaged in abnormal driving behavior if the criteria included in the subset are sensed by the sensor set occurring in any order. The method where the subset is variable based on a geographic location of the remote vehicle. The method where an edge server transmits a wireless message to the ego vehicle to specify which subset of criteria correspond to the abnormal driving behavior. Implementations of the described techniques may include hardware, a method or process, or computer software on a computer-accessible medium.

One general aspect includes a system of an ego vehicle. The system also includes a non-transitory memory; a sensor set; and a processor communicatively coupled to the non-transitory memory and the sensor set, where the non-transitory memory stores computer readable code that is operable, when executed by the processor, to cause the processor to execute steps including: sensing, by the sensor set, a remote vehicle to generate sensor data describing driving behavior of the remote vehicle; comparing the sensor data to a set of criteria for abnormal driving behavior; determining that a subset of the set of criteria are described by the sensor data, where the subset satisfy a threshold for early detection of abnormal driving behavior; and determining that the remote vehicle is engaged in abnormal driving behavior based on satisfaction of threshold. Other embodiments of this aspect include corresponding computer systems, apparatus, and computer programs recorded on one or more computer storage devices, each configured to perform the actions of the methods.

One general aspect includes a computer program product including computer code stored on a non-transitory memory that is operable when executed by an onboard vehicle computer of an ego vehicle, to cause the onboard vehicle computer to execute operations including: sensing, by a sensor set, a remote vehicle to generate sensor data describing driving behavior of the remote vehicle; comparing the sensor data to a set of criteria for abnormal driving behavior; determining that a subset of the set of criteria are described by the sensor data, wherein the subset satisfy a threshold for early detection of abnormal driving behavior; and determining that the remote vehicle is engaged in abnormal driving behavior based on satisfaction of threshold. Other embodiments of this aspect include corresponding computer systems, apparatus, and computer programs recorded on one or more computer storage devices, each configured to perform the actions of the methods.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an operating environment for a detection system according to some embodiments.

FIG. 2 is a block diagram illustrating an example computer system including a detection system according to some embodiments.

FIG. 3 is a flowchart of an example method for early detection of abnormal driving behavior according to some embodiments.

FIGS. 4A and 4B a flowchart of an example method for early detection of abnormal driving behavior according to some embodiments.

### DETAILED DESCRIPTION

Described herein are embodiments of a detection system. The functionality of the detection system is now introduced according to some embodiments.

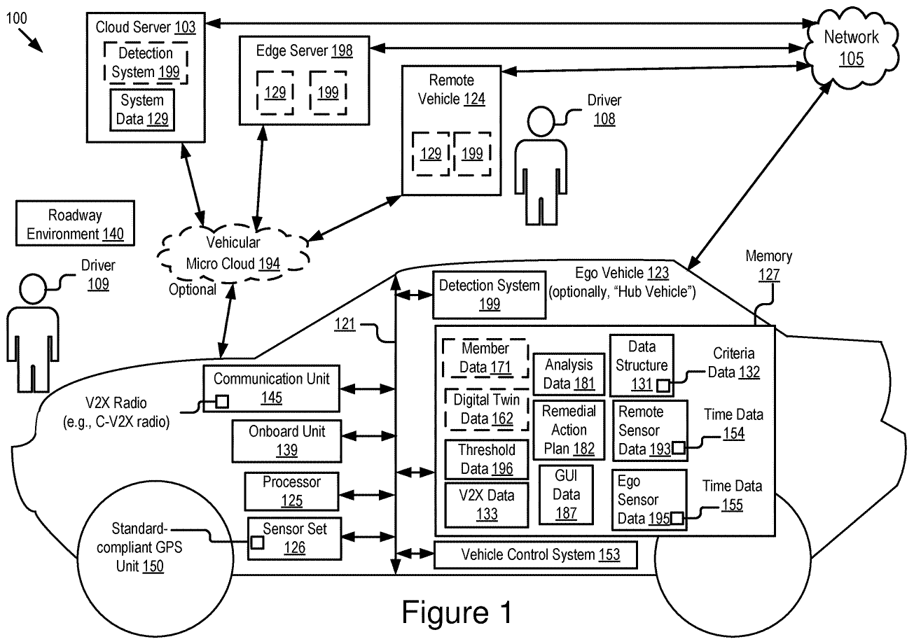

Vehicles include onboard sensors that constantly record sensor data describing their external environment. In some embodiments, the sensor data is time stamped so that individual sensor measurements recorded by the onboard sensors include a time stamp describing the time when the sensor measurement was recorded. Time data includes digital data that describes the time stamps for the sensor measurements that are described by the sensor data. Vehicles transmit V2X messages to one another. Examples of the time data according to some embodiments include the time data 154, 155 depicted in FIG. 1.

The sensor data includes digital data describing the sensor measurements recorded by the onboard sensors (e.g., the sensor set). In some embodiments, instances of sensor data describe one or more sensor measurements, and the instances of sensor data are timestamped with time data to indicate the time when the one or more sensor measurements were recorded.

Remote sensor data includes digital data that describes the sensor measurements recorded by the sensor set of a remote vehicle. An example of the remote sensor data in some embodiments includes the remote sensor data 193 depicted in FIG. 1. In some embodiments, the sensor measurements described by the remote sensor data 193 are time stamped. Time data 154 includes digital data that describes the time stamps for the sensor measurements described by the remote sensor data 193.

Ego sensor data includes digital data that describes the sensor measurements recorded by the sensor set of an ego vehicle. An example of the ego sensor data in some embodiments includes the ego sensor data 195 depicted in FIG. 1. In some embodiments, the sensor measurements described by the ego sensor data 195 are time stamped. Time data 155 includes digital data that describes the time stamps for the sensor measurements described by the ego sensor data 195.

V2X messages include V2X data in their payload. The V2X data includes, among other things, the sensor data that vehicles record using their sensor sets. Vehicles that receive these V2X messages use this V2X data to improve their awareness of their environment. For vehicles that include Advanced Driver Assistance Systems (ADAS systems) or autonomous driving systems, the V2X data is inputted to these systems so that they can better understand their driving environment when providing their functionality.

An example of one specific type of sensor data includes GPS data. “GPS” refers to “geographic positioning system.” The GPS data includes digital data that describes the geographic location of an object such as a vehicle or a smartphone.

An example of the V2X data according to some embodiments includes the V2X data 133 depicted in FIG. 1. For example, with reference to FIG. 1, the remote sensor data 193 is received by the communication unit 145 of the ego vehicle 123 via a V2X transmission that includes V2X data 133 including the remote sensor data 193 as its payload; the detection system 199 of the ego vehicle then parses the remote sensor data 193 from the V2X data 133 and stores the V2X data 133 and the remote sensor data 193 in the memory 127 of the ego vehicle 123. The remote sensor data 193 serves as a source of data, in addition to the ego sensor data 195 and the criteria data 132 stored in the data structure 131, for identifying the occurrence of abnormal driving behavior by the driver 108 of the remote vehicle 124.

The driver 108 is a human driver of the remote vehicle 124. The driver 109 is a human driver of the ego vehicle 123.

In some embodiments, the V2X data 133 is received by the ego vehicle 123 because the ego vehicle 123 and the remote vehicle 124 are members of the same vehicular micro cloud 194. Vehicular micro clouds are described in more detail below according to some embodiments.

A vehicle control system is an onboard system of a vehicle that controls the operation of a functionality of the vehicle. ADAS systems and autonomous driving systems are examples of vehicle control systems. Examples of the vehicle control system according to some embodiments includes the vehicle control system 153 depicted in FIG. 1.

Example General Method

In some embodiments, the detection system includes code and routines that are operable, when executed by a processor, to cause the processor to execute one or more steps of an example general method described herein. The detection system may be an element of one or more of the following: an ego vehicle; a remote connected vehicle; a cloud server; and an edge server installed in a roadway device such as a roadside unit (RSU). As described, the detection system is an element of the ego vehicle, but this description is not intended to be limiting.

In some embodiments, these steps are executed by a processor or onboard vehicle computer of an ego vehicle. The ego vehicle is a connected vehicle. A connected vehicle is a vehicle that includes a communication unit. An example of a communication unit includes the communication unit 145 depicted in FIG. 1. The remote connected vehicle is also a connected vehicle, and so, it includes a communication unit.

As used herein, the term “wireless message” refers to a V2X message transmitted by a communication unit of a connected vehicle such as a remote connected vehicle or the ego vehicle.

The example general method is now described. In some embodiments, one or more steps of the example general method are skipped or modified. For example, in one embodiment the detection system builds one or more of the criteria data and the data structure itself. However, in some embodiments, the data structure including the criteria data are elements of an edge server or cloud server and the detection system of the ego vehicle uses wireless communication with a network (e.g., V2X communication) to download one or more of the criteria data and the data structure from the edge server or the cloud server. In some embodiments, one or more of the criteria data and the data structure itself are configured to be geographically specific. For example, an RSU includes and edge server that includes a data structure that organizes criteria data that are specific to the geographical area that is serviced by the RSU. This is beneficial, for example, if a particular geographic area is prone to unique types of abnormal driving behavior or unique patterns of criteria which correspond to the occurrence of a particular abnormal driving behavior. The embodiment described below for the example general method assumes that the detection system of an ego vehicle downloads criteria data from a cloud server and organizes the criteria data into a data structure locally in the memory of the ego vehicle.

The steps of the example general method may be executed in any order, and not necessarily the order presented. In some embodiments, a plurality of vehicles on a roadway include instances of the detection system and the detection systems of these vehicles also execute some or all of the steps described below. For example, one or more of these steps are executed by the members of a vehicular micro cloud in some embodiments. Vehicular micro clouds are not a requirement of the detection system.

The steps of the example general method are now described according to some embodiments.

Step 1: The detection system of an ego vehicle downloads criteria data from a cloud server via a network such as the network 105 depicted in FIG. 1. The network is described in more detail below with reference to the network 105 depicted in FIG. 1.

In some embodiments, the cloud server includes a non-transitory memory that stores system data. System data includes some or all of the digital data described herein. An example of the system data according to some embodiments includes the system data 129 depicted in FIG. 1. The cloud server includes a hardware server. An example of the cloud server includes the cloud server 103 depicted in FIG. 1.

In some embodiments, the detection system of the ego vehicle downloads the criteria data from an edge server instead of downloading it from a cloud server. An example of the edge server according to some embodiments includes the edge server 198 depicted in FIG. 1. An edge server includes a hardware server. In some embodiments, the edge server is an element of a roadside device such as an RSU.

Step 2: The detection system of the ego vehicle organizes the criteria data into a data structure. A data structure includes a non-transitory memory that organizes a set of data such as the criteria data. An example of the data structure according to some embodiments includes the data structure 131 depicted in FIG. 1. In some embodiments, the data structure is an element of an ego vehicle.

Step 3: The detection system causes the sensor set of the ego vehicle to record ego sensor data. The ego sensor data includes digital data that describes the sensor measurements of the sensors that are included in the sensor set of the ego vehicle. In some embodiments, the individual sensor measurements are time stamped so an instance of ego sensor data describes both a sensor measurement and when this measurement was recorded. In some embodiments, the ego sensor data includes time data that describes the timestamps for the sensor measurements.

In some embodiments, the sensor measurements described by the ego sensor data describe one or more of the following: the ego vehicle over time including its location in a roadway environment over time; the location of the ego vehicle relative to other objects within the roadway environment over time; the driver's operation of the ego vehicle over time, the presence of other objects over time within the roadway environment that includes the ego vehicle; the location of these objects in the roadway over time relative to other objects (e.g., the location of these other objects relative to one another and relative to the ego vehicle); and the behavior of these other objects over time (e.g., a remote connected vehicle being driven abnormally).

An example of the ego sensor data according to some embodiments includes the ego sensor data 195 depicted in FIG. 1. An example of the time data associated with the ego sensor data 195 according to some embodiments includes the time data 155 depicted in FIG. 1.

The sensors included in the sensor set, and the type of measurements they can record, are described in more detail below.

Step 4: (Optional) A set of one or more remote vehicles in sensor range of the ego vehicle include their own instance of the detection system. The detection system of these remote vehicles causes the sensor sets of these remote vehicles to record sensor measurements of their roadway environment. These sensor measurements include sensor measurements of the ego vehicle and the behavior of the ego vehicle over time.

The sensor measurements recorded by an individual remote connected vehicle from the set of remote vehicles is described by remote sensor data. The remote sensor data includes digital data that describes the sensor measurements of the sensors that are included in the sensor set of the remote connected vehicle. In some embodiments, the individual sensor measurements are time stamped so an instance of remote sensor data describes both a sensor measurement and when this measurement was recorded. In some embodiments, the remote sensor data includes time data that describes the timestamps for the sensor measurements.

In some embodiments, the sensor measurements described by the remote sensor data describe one or more of the following: the remote connected vehicle over time including its location in a roadway environment over time; the location of the remote connected vehicle relative to other objects within the roadway environment over time; a driver's operation of the remote connected vehicle over time, the presence of other objects (including the presence of the ego vehicle) over time within the roadway environment that includes the remote connected vehicle; the location of these objects (including the location of the ego vehicle) in the roadway over time relative to other objects (e.g., the location of the ego vehicle relative to the remote connected vehicle as measured from the perspective of the remote connected vehicle); and the behavior of these other objects (including the behavior of the ego vehicle) over time (e.g., abnormal driving behavior of the ego vehicle as recorded by the sensors of the remote connected vehicle as well as an event which preceded the abnormal driving behavior).

An example of the remote sensor data according to some embodiments includes the remote sensor data 193 depicted in FIG. 1. An example of the time data associated with the remote sensor data 193 according to some embodiments includes the time data 154 depicted in FIG. 1.

The sensors included in the sensor sets of the remote vehicles are similar to those included in the ego vehicle.

In some embodiments, the ego vehicle and the set of remote vehicles described in step 4 are members of a vehicular micro cloud. In some embodiments, a detection system of a vehicle that includes a detection system (e.g., the ego vehicle) initiates the creation of the vehicular micro cloud responsive to determining that one of the vehicles in the roadway environment (e.g., a remote vehicle) is being driven abnormally. Vehicular micro clouds are described in more detail herein. For example, a description of vehicular micro clouds is provided following the description of the example general method.

Step 5: (Optional) The detection systems of the set of remote vehicles described in step 3 build V2X messages including V2X data. V2X data includes digital data that is the payload for a V2X message. An example of the V2X data according to some embodiments includes the V2X data 133 depicted in FIG. 1. In some embodiments, the detection systems of the set of remote vehicles described in step 3 build V2X data 133 including their remote sensor data 193 and time data 154; these detection systems build V2X messages including the V2X data 133 as their payloads and cause the communication units of these remote vehicles to transmit V2X messages including the V2X messages. In some embodiments, each instance of V2X data 133 for each remote connected vehicle includes a plurality of instances of remote sensor data 193 and corresponding time data 154 for the sensor measurements described by this remote sensor data 193. Each of the remote vehicles builds its own V2X message including its own V2X data. Each detection system of each remote connected vehicle causes the communication unit of each of the remote vehicles to broadcast its own V2X message.

In some embodiments, the V2X data 133 includes analysis data 181 generated by the detection system of the remote vehicle that indicates a characteristic of one or more other remote vehicles. This analysis data 181 is useful for providing feedback to the detection system of an ego vehicle so that false positive detections of abnormal driving is reduced. For example, assume that a particular remote vehicle is operated by a cautious or conservative driver that has a pattern of (1) maintaining a large distance to collision between their vehicle and a preceding vehicle that is traveling in front of their vehicle and (2) not being an aggressive driver. The analysis data 181 indicates this characteristic of the particular remote vehicle. The detection system of an ego vehicle preliminarily determines that the particular remote vehicle is demonstrating abnormal driving behavior of the aggressive driver type based on the ego sensor data generated by the sensor set of the ego vehicle indicating the particular remote vehicle maintains a large distance to collision, which is a subset of the total set of criteria that indicate abnormal driving behavior of the distracted driver type. However, the detection system of the ego vehicle parses the analysis data 181 from the V2X data 133 and determines that the particular remote vehicle is not demonstrating abnormal driving behavior but is instead demonstrating cautious or conservative driving behavior, thereby beneficially overriding the preliminary determination and avoiding a false positive.

A large distance to collision includes a distance between a particular vehicle and a preceding vehicle traveling immediately ahead of the particular vehicle wherein the distance satisfies a threshold for a large distance. The threshold for the large distance is described by the threshold data 196. For example, a distance greater than three lengths of the particular vehicle satisfies a threshold for a large distance to collision.

A short distance to collision includes a distance between a particular vehicle and a preceding vehicle traveling immediately ahead of the particular vehicle wherein the distance satisfies a threshold for a short distance. The threshold for the short distance is described by the threshold data 196. For example, a distance shorter than one length of the particular vehicle satisfies a threshold for a short distance to collision.

A high speed includes a speed or velocity of a particular vehicle that satisfies a threshold for high speed. The threshold for the high speed is described by the threshold data 196. For example, a speed that is 10 miles per hour faster than the posted speed limit satisfies a threshold for a high speed.

A slow speed includes a speed or velocity of a particular vehicle that satisfies a threshold for slow speed. The threshold for the slow speed is described by the threshold data 196. For example, a speed that is 10 miles per hour slower than the posted speed limit satisfies a threshold for a slow speed.

A false positive detection of abnormal driving behavior occurs when the detection system of an ego vehicle determines that a particular vehicle is demonstrating abnormal driving behavior based on a subset of criteria data being determined to be present in the sensor data by the detection system of the ego vehicle (e.g., the subset of criteria are satisfied based on analysis of the sensor data) when further analysis of additional sensor data indicates that the particular vehicle was not actually demonstrating abnormal driving behavior.

A behavior includes an action or characteristic of a vehicle that is measurable by a sensor included in the sensor set of a vehicle such as the ego vehicle.

In some embodiments, the detection system of an ego vehicle reduces false positives by communicating with the detection system of an edge server that is installed in a RSU and responsible for managing a particular geographic area. In some embodiments, the determination of the edge server identifies patterns of abnormal driving behavior that are more likely in the geographic area and these patterns are described by the criteria data included in a data structure that is maintained by the detection system of the edge server. This criteria data is referred to as location-based criteria data. The detection system of the edge server transmits V2X messages to the detection system of the ego vehicle that a copy of the location-based criteria data to the detection system of the ego vehicle. In some embodiments, the process described in this paragraph is referred to as “location-based pre-knowledge.”

In some embodiments, the detection system of an ego vehicle reduces false positives by communicating with the detection systems of nearby remote vehicles to request their analysis data for a particular remote vehicle that preliminarily engaging in abnormal driving behavior. The analysis data provided by the remote vehicles is used to confirm or deny the preliminary determination by the detection system of the ego vehicle.

Step 6: (Optional) The V2X messages broadcast at step 5 are received by the communication unit of the ego vehicle. The detection system of the ego vehicle parses the V2X data 133 from the V2X messages received by the communication unit of the ego vehicle and stores the V2X data 133 in the memory of the ego vehicle. The detection system of the ego vehicle parses the remote sensor data 193 and the time data 154 from these instances of V2X data 133 (and optionally the analysis data 181) and stores the remote sensor data 193 and the time data 154 (and optionally the analysis data 181 in the memory of the ego vehicle. In this way the detection system of the ego vehicle receives the remote sensor data 193 and the time data 154 (and optionally the analysis data 181 from a set of remote vehicles. The detection system of the ego vehicle therefore has access to a rich data set including its own ego sensor data 195 and the remote sensor data 193 of a set of remote vehicles 124 to consider in the subsequent steps of this example general method.

Step 7: The detection system of the ego vehicle analyzes the available sensor data. This sensor data includes the ego sensor data and, optionally, one or more sets of remote sensor data. The ego sensor data and the remote sensor data are referred to separately or collectively as the “sensor data.” The detection system of the ego vehicle analyzes the sensor data relative to the criteria data to identify if any remote vehicles are behaving abnormally.

For example, the detection system of the ego vehicle analyzes the sensor data to determine the presence of patterns of behavior for one or more remote vehicles within the sensor data. The detection system compares these patterns to the sets of criteria for a plurality of types of abnormal driving behavior as described by the criteria data.

In some embodiments, the set of criteria determined by the detection system is based on one or more of the following: the most repeating pattern of driving behavior; and the most contrasting pattern of driving behavior. In some embodiments, the detection system of the ego vehicle includes code and routines that check for both the most repeating pattern of behavior and the most contrasting pattern of behavior when determining the sets of criteria for the plurality of types of abnormal driving behavior.

In some embodiments, the criteria data also describes, for each abnormal driving behavior type, which subsets of criteria trigger an early determination that a vehicle is demonstrating abnormal driving behavior. Based on this comparison, the detection system of the ego vehicle determines if any of the subsets of criteria are present such that an early determination that a remote vehicle is demonstrating abnormal driving behavior is triggered.

In some embodiments, this step may also be used to determine if the ego vehicle itself is behaving abnormally. For example, the detection system of the ego vehicle analyzes the sensor data to determine the presence of patterns of behavior for the ego vehicle within the sensor data. The detection system compares these patterns to the sets of criteria for a plurality of types of abnormal driving behavior as described by the criteria data. Based on this comparison, the detection system of the ego vehicle determines if any of the subsets of criteria are present such that an early determination that the ego vehicle is demonstrating abnormal driving behavior is triggered.

If abnormal behavior is identified by the detection system at step 7, then the example general method proceeds to step 8. If abnormal behavior is not identified by the detection system at step 7, then the example general method restarts at step 1 and proceeds from there until abnormal behavior is identified at step 7. The steps of this example general method subsequent to step 7 assume that the detection system identifies abnormal behavior at step 7.

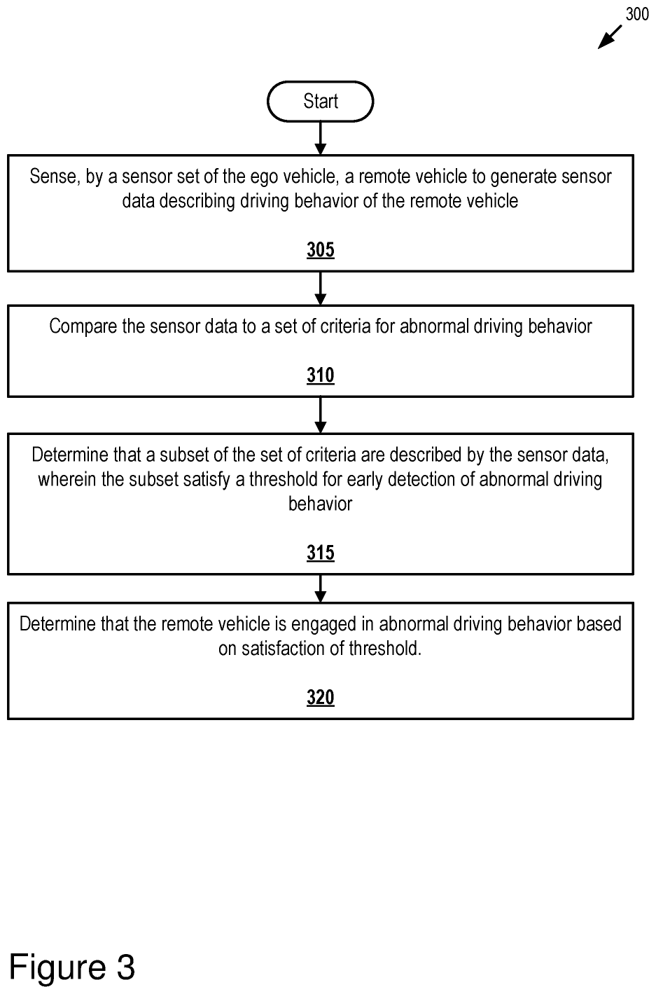

In some embodiments, this step 6 corresponds to steps 310-315 in the method 300 depicted in FIG. 3 according to some embodiments.

Step 8: (Optional) In some embodiments, the detection system of the ego vehicle takes step to form a vehicular micro cloud responsive to identifying the abnormal driving behavior at step 7. The ability of the detection system to form a vehicular micro cloud is beneficial, for example, since it provides the detection system of the ego vehicle with access to greater computational resources of a plurality of connected vehicles in order to provide services such as one or more of the following: selecting a remedial action plan to reduce, minimize, or remove the negative effect of the abnormal behavior; and implementing the remedial action plan to reduce, minimize, or remove the negative effect of the abnormal behavior. There are numerous other ways that the formation of a vehicular micro cloud benefits the functionality of the detection system. Vehicular micro clouds are described in more detail herein. For example, a description of vehicular micro clouds follows the description of this example general method.

Step 9: The detection system of the ego vehicle (or a hub vehicle of a vehicular micro cloud) selects a remedial action plan that corresponds to the type of abnormal driving behavior identified by the detection system.

Step 10: The detection system of the ego vehicle (or a hub vehicle of a vehicular micro cloud) takes steps to implement the remedial action plan. The remedial action plan may include taking steps to notify one or more drivers of innocent vehicles about the presence of the abnormal driving behavior and which vehicle is engaged in the abnormal driving behavior. In some embodiments, the remedial action plan includes providing an input to an ADAS system or an autonomous driving system which then executes steps configured to reduce the negative impact of the abnormal driving behavior.

Step 11: (Optional) The detection system continues to monitor the vehicle that was identified as demonstrating abnormal driving behavior to determine if the determination that this vehicle was demonstrating abnormal driving behavior was correct. If a determination is made that the vehicle was not actually engaged in abnormal driving behavior (e.g., a false positive), then the detection system takes steps to modify the criteria data for this type of abnormal driving behavior so that future false positive determinations are reduced. For example, the subset of criteria that trigger the determination that abnormal driving behavior is occurring is modified. In some embodiments, the detection system uploads the results of step 11 and other system data relating to the false positive to a cloud server or edge server which then determines the changes to be made to the criteria data based on this instance of false positive identification as well as one or more others that are made by the detection systems of other vehicles. In this way, the functionality of the determination improves over time as false positives are reduced over time.

Vehicular Micro Clouds

Vehicular micro clouds are an optional feature of some of the embodiments described herein. Some of the embodiments described herein include vehicular micro clouds. For example, some or all of the vehicles which are registered with the detection system are connected vehicles (e.g., vehicles that include a processor, a communication unit, and an instance of the detection system) and members of a vehicular micro cloud. In some embodiments, the vehicular micro cloud hosts the detection system in a distributed fashion using the computing resources of the vehicles that are members of the vehicular micro cloud so that a cloud server and/or an edge server is not strictly necessary to provide the service of the detection system to the users of the detection system. Some of the embodiments described herein do not include vehicular micro cloud.

In some embodiments, a server such as a cloud server and/or an edge server is also an element of the vehicle micro cloud.

In some embodiments, a vehicular micro cloud includes a group of connected vehicles where vehicles perform task(s) cooperatively/collaboratively. Vehicular micro clouds can be divided into two categories based on their mobility: (1) stationary; and (2) mobile.

In the stationary cloud, a certain geographical region is designated as the vehicular micro cloud region, and vehicles entering that region contribute their resources for vehicular cloud services. A stationary vehicular micro cloud is sometimes referred to as a “static” vehicular micro cloud.

In the mobile vehicular cloud, on the other hand, the vehicular micro cloud moves as the micro cloud members move. A mobile vehicular micro cloud is sometimes referred to as a “dynamic” vehicular micro cloud.

In some embodiments, as an optional operating environment, the detection system is hosted by a plurality of members of a vehicular micro cloud. These members are also registered with the detection system. The detection system causes the vehicles, which each include an instance of the detection system or at least a subset of the code and routines of the detection system, to execute steps to form the vehicular micro cloud.

Member data includes digital data that describes information about a vehicular micro cloud and its members. For example, the member data is digital data that describes the identity of the members of the vehicular micro cloud and their specific computing resources; all members of the vehicular micro cloud make their computing resources available to one another for their collective benefit. An example of the member data according to some embodiments includes the member data 171 depicted in FIG. 1. In some embodiments, the detection system 199 cause the communication unit to transmit a wireless message to candidates for membership in the vehicular micro cloud that causes these candidates to join the vehicular micro cloud. The list of candidates is determined by the detection system based on the technical data which is transmitted by the candidates to one another via BSMs; in some embodiments, these BSMs also include sensor data recorded by the vehicles that transmit the BSMs. Vehicular micro clouds are described in more detail below according to some embodiments.

Vehicular micro clouds provide vehicular micro cloud tasks. A vehicular micro cloud task includes any task executed by a vehicular micro cloud or a group of vehicular micro clouds. As used herein, the terms “task” and “vehicular micro cloud task” refer to the same thing. A “sub-task” as used herein is a portion of a task or vehicular micro cloud task. An example of a task includes, for example, determining and executing vehicle driving maneuvers that eliminates an origin of an abnormal driving behavior identified by the detection system.

In some embodiments, the vehicular micro cloud tasks provided by the vehicular micro cloud includes some or all of the tasks which are necessary to provide the functionality of the detection system described herein. In some embodiments, a vehicular micro cloud includes a group of connected vehicles that communicate with one another via V2X messages to provide the service of the detection system to the ego vehicle and/or the members of the vehicular micro cloud.

The vehicular micro cloud includes multiple members. A member of the vehicular micro cloud includes a connected vehicle that sends and receives V2X messages via the network (e.g., the network 105 depicted in FIG. 1). In some embodiments, the network is a serverless ad-hock vehicular network. In some embodiments, the members of the network are nodes of the serverless ad-hoc vehicular network.

In some embodiments, a serverless ad-hoc vehicular network is “serverless” because the serverless ad-hoc vehicular network does not include a server. In some embodiments, a serverless ad-hoc vehicular network is “ad-hoc” because the serverless ad-hoc vehicular network is formed its members when it is determined by one or more of the members to be needed or necessary. In some embodiments, a serverless ad-hoc vehicular network is “vehicular” because the serverless ad-hoc vehicular network only includes connected vehicles as its endpoints. In some embodiments, the term “network” refers to a V2V network.

In some embodiments, the vehicular micro cloud only includes vehicles. For example, the serverless ad-hoc network does not include the following: an infrastructure device, a base station, a roadway device, an edge server, an edge node, and a cloud server. An infrastructure device includes any hardware infrastructure device in a roadway environment such as a traffic signal, traffic light, traffic sign, or any other hardware device that has or does not have the ability to wirelessly communicate with a wireless network.

In some embodiments, the serverless ad-hoc vehicular network includes a set of sensor rich vehicles. A sensor rich vehicle is a connected vehicle that includes a rich sensor set.

In some embodiments, an operating environment that includes the serverless ad-hoc vehicular network also includes a legacy vehicle. A legacy vehicle is a connected vehicle that includes a legacy sensor set. The overall sensing ability of the rich sensor set is greater than the overall sensing ability of the legacy sensor set. For example, a roadway environment includes a set of sensor rich vehicles and a legacy vehicle; the rich sensor set is operable to generate sensor measurements that more accurately describe the geographic locations of objects in the roadway environment when compared to the sensor measurements generated by the legacy sensor set.

In some embodiments, the legacy vehicle is an element of the serverless ad-hoc vehicular network. In some embodiments, the legacy vehicle is not an element of the serverless ad-hoc vehicular network but is able to provide shared rides to users because the driver of the legacy vehicle has a smart device (e.g., an electronic processor-based computing device such as a smartphone, smartwatch, tablet computer, laptop, smart glasses, etc.) which they use to receive information that enables them to participate as registered vehicles that provide shared rides to the users of the Service provided by the detection system.

In some embodiments, the serverless ad-hoc vehicular network is a vehicular micro cloud. It is not a requirement of the embodiments described herein that the serverless ad-hoc vehicular network is a vehicular micro cloud. Accordingly, in some embodiments the serverless ad-hoc vehicular network is not a vehicular micro cloud.

In some embodiments, the serverless ad-hoc vehicular network includes a similar structure that is operable to provide some or all of the functionality as a vehicular micro cloud. Accordingly, a vehicular micro cloud is now described according to some embodiments to provide an understanding of the structure and functionality of the serverless ad-hoc vehicular network according to some embodiments. When describing the vehicular micro cloud, the term “vehicular micro cloud” can be replaced by the term “vehicular micro cloud” since a vehicular micro cloud is an example of a vehicular micro cloud in some embodiments.

Distributed data storage and computing by a group of connected vehicles (i.e., a “vehicular micro cloud”) is a promising solution to cope with an increasing network traffic generated for and by connected vehicles. Vehicles collaboratively store (or cache) data sets in their onboard data storage devices and compute and share these data sets over vehicle-to-vehicle (V2V) networks as requested by other vehicles. Using vehicular micro clouds removes the need for connected vehicles to access remote cloud servers or edge servers by vehicle-to-network (V2N) communications (e.g., by cellular networks) whenever they need to get access to unused computing resources such as shared data (e.g., some or all of the system data 129 described herein), shared computational power, shared bandwidth, shared memory, and cloudification services.

Some of the embodiments described herein are motivated by the emerging concept of “vehicle cloudification.” Vehicle cloudification means that vehicles equipped with on-board computer unit(s) and wireless communication functionalities form a cluster, called a vehicular micro cloud, and collaborate with other micro cloud members over V2V networks or V2X networks to perform computation, data storage, and data communication tasks in an efficient way. These types of tasks are referred to herein as “vehicular micro cloud tasks” if plural, or a “vehicular micro cloud task” if singular.

In some embodiments, a vehicular micro cloud task includes any computational, data storage, or data communication task collaboratively performed by a plurality of the members of a vehicular micro cloud. In some embodiments, the set of tasks described above with regards to the example general method include one or more vehicular micro cloud tasks as described herein.

In some embodiments, a computational task includes a processor executing code and routines to output a result. The result includes digital data that describes the output of executing the code and routines. For example, a computational task includes a processor executing code and routines to solve a problem (e.g., identifying the origin of an abnormal driving behavior exhibited by the ego vehicle), and the result includes digital data that describes the solution to the problem (e.g., selecting and/or implementing the selected strategy described by the selected strategy data). In some embodiments, the computational task is broken down into sub-tasks whose completion is equivalent to completion of the computational task. In this way, the processors of a plurality of micro cloud members are assigned different sub-tasks configured to complete the computational task; the micro cloud members take steps to complete the sub-tasks in parallel and share the result of the completion of the sub-task with one another via V2X wireless communication. In this way, the plurality of micro cloud members work together collaboratively to complete the computational task. The processors include, for example, the onboard units or electronic control units (ECUs) of a plurality of connected vehicles that are micro cloud members.

In some embodiments, a data storage task includes a processor storing digital data in a memory of a connected vehicle. For example, a digital data file which is too big to be stored in the memory of any one vehicle is stored in the memory of multiple vehicles. In some embodiments, the data storage task is broken down into sub-tasks whose completion is equivalent to completion of the data storage task. In this way, the processors of a plurality of micro cloud members are assigned different sub-tasks configured to complete the data storage task; the micro cloud members take steps to complete the sub-tasks in parallel and share the result of the completion of the sub-task with one another via V2X wireless communication. In this way, the plurality of micro cloud members work together collaboratively to complete the data storage task. For example, a sub-task for a data storage task includes storing a portion of a digital data file in a memory of a micro cloud member; other micro cloud members are assigned sub-tasks to store the remaining portions of digital data file in their memories so that collectively the entire file is stored across the vehicular micro cloud or a sub-set of the vehicular micro cloud.

In some embodiments, a data communication task includes a processor using some or all of the network bandwidth available to the processor (e.g., via the communication unit of the connected vehicle) to transmit a portion a V2X wireless message to another endpoint. For example, a V2X wireless message includes a payload whose file size is too big to be transmitted using the bandwidth available to any one vehicle and so the payload is broken into segments and transmitted at the same time (or contemporaneously) via multiple wireless messages by multiple micro cloud members. In some embodiments, the data communication task is broken down into sub-tasks whose completion is equivalent to completion of the data storage task. In this way, the processors of a plurality of micro cloud members are assigned different sub-tasks configured to complete the data storage task; the micro cloud members take steps to complete the sub-tasks in parallel and share the result of the completion of the sub-task with one another via V2X wireless communication. In this way, the plurality of micro cloud members work together collaboratively to complete the data storage task. For example, a sub-task for a data communication task includes transmitting a portion of a payload for a V2X message to a designated endpoint; other micro cloud members are assigned sub-tasks to transmit the remaining portions of payload using their available bandwidth so that collectively the entire payload is transmitted.

In some embodiments, a vehicular micro cloud task includes determining a remedial action plan considering the combination of identified abnormal driving behaviors and other variables such as weather conditions, lighting conditions, road-surface conditions (e.g., wet or icy conditions), roadway congestion (e.g., number of vehicles per unit of measurement such as feet or meters), and road geometry conditions.

In some embodiments, a vehicular micro cloud task is collaboratively performed by the plurality of members executing computing processes in parallel which are configured to complete the execution of the vehicular micro cloud task.

In some embodiments, a vehicular micro cloud includes a plurality of members that execute computing processes whose completion results in the execution of a vehicular micro cloud task. For example, the serverless ad-hoc vehicular network provides a vehicular micro cloud task to a legacy vehicle.

Vehicular micro clouds are beneficial, for example, because they help vehicles to perform computationally expensive tasks (e.g., determining the analysis data, executing the digital twin simulations, etc.) that they could not perform alone or store large data sets that they could not store alone. In some embodiments, the computational power of a solitary ego vehicle is sufficient to execute these tasks.

Vehicular micro clouds are described in the patent applications that are incorporated by reference in this paragraph. This patent application is related to the following patent applications, the entirety of each of which is incorporated herein by reference: U.S. patent application Ser. No. 15/358,567 filed on Nov. 22, 2016 and entitled “Storage Service for Mobile Nodes in a Roadway Area”; U.S. patent application Ser. No. 15/799,442 filed on Oct. 31, 2017 and entitled “Service Discovery and Provisioning for a Macro-Vehicular Cloud”; U.S. patent application Ser. No. 15/845,945 filed on Dec. 18, 2017 and entitled “Managed Selection of a Geographical Location for a Micro-Vehicular Cloud”; U.S. patent application Ser. No. 15/799,963 filed on Oct. 31, 2017 and entitled “Identifying a Geographic Location for a Stationary Micro-Vehicular Cloud”; U.S. patent application Ser. No. 16/443,087 filed on Jun. 17, 2019 and entitled “Cooperative Parking Space Search by a Vehicular Micro Cloud”; U.S. patent application Ser. No. 16/739,949 filed on Jan. 10, 2020 and entitled “Vehicular Micro Clouds for On-demand Vehicle Queue Analysis”; U.S. patent application Ser. No. 16/735,612 filed on Jan. 6, 2020 and entitled “Vehicular Micro Cloud Hubs”; U.S. patent application Ser. No. 16/387,518 filed on Apr. 17, 2019 and entitled “Reorganizing Autonomous Entities for Improved Vehicular Micro Cloud Operation”; U.S. patent application Ser. No. 16/273,134 filed on Feb. 11, 2019 and entitled “Anomaly Mapping by Vehicular Micro Clouds”; U.S. patent application Ser. No. 16/246,334 filed on Jan. 11, 2019 and entitled “On-demand Formation of Stationary Vehicular Micro Clouds”; and U.S. patent application Ser. No. 16/200,578 filed on Nov. 26, 2018 and entitled “Mobility-oriented Data Replication in a Vehicular Micro Cloud.”

In some embodiments, the functionality provided by the detection system is a task provided by the vehicular micro cloud. For example, the detection system is an element of a hub of a vehicular micro cloud. The detection system receives a set of wireless messages, and this triggers the detection system to form a vehicular micro cloud. The detection system processes V2X data for the benefit of one or more members of the vehicular micro cloud. For example, the ego vehicle includes computational power that exceeds that of another member, and the ego vehicle processes wireless messages for this member which would otherwise be unable to do so, or unable to do so in a timeframe that satisfies a threshold for latency. Hub vehicles are described in more detail below. In this way the members of the vehicular micro cloud work collaboratively to identify abnormal driving behaviors and determine remedial action plans for the combination of identified abnormal driving behaviors.

The endpoints that are part of the vehicular micro cloud may be referred to herein as “members,” “micro cloud members,” or “member vehicles.” Examples of members include one or more of the following: a connected vehicle; an edge server; a cloud server; any other connected device that has computing resources and has been invited to join the vehicular micro cloud by a handshake process. In some embodiments, the term “member vehicle” specifically refers to only connected vehicles that are members of the vehicular micro cloud whereas the terms “members” or “micro cloud members” is a broader term that may refer to one or more of the following: endpoints that are vehicles; and endpoints that are not vehicles such as roadside units.

In some embodiments, the communication unit of an ego vehicle includes a V2X radio. The V2X radio operates in compliance with a V2X protocol. In some embodiments, the V2X radio is a cellular-V2X radio (“C-V2X radio”). In some embodiments, the V2X radio broadcasts Basic Safety Messages (“BSM” or “safety message” if singular, “BSMs” or “safety messages” if plural). In some embodiments, the safety messages broadcast by the communication unit include some or all of the system data as its payload. In some embodiments, the system data is included in part 2 of the safety message as specified by the Dedicated Short-Range Communication (DSRC) protocol. In some embodiments, the payload includes digital data that describes, among other things, sensor data that describes a roadway environment that includes the members of the vehicular micro cloud.

As used herein, the term “vehicle” refers to a connected vehicle. For example, the ego vehicle and remote connected vehicle depicted in FIG. 1 are connected vehicles.

A connected vehicle is a conveyance, such as an automobile, that includes a communication unit that enables the conveyance to send and receive wireless messages via one or more vehicular networks. The embodiments described herein are beneficial for both drivers of human-driven vehicles as well as the autonomous driving systems of autonomous vehicles. For example, the detection system improves the performance of a vehicle control system, which benefits the performance of the vehicle itself by enabling it to operate more safety or in a manner that is more satisfactory to a human driver of the ego vehicle.

In some embodiments, the detection system improves the performance of a network because it beneficially takes steps to enable the completion of vehicular micro cloud tasks.

In some embodiments, the detection system improves the performance of a connected vehicle because it beneficially enables the onboard vehicle computer of a vehicle to identify an origin of its abnormal driving behavior and implement a strategy so that the events which originated the abnormal driving behavior do not occur in the future or do not occur sufficient to precipitate the abnormal driving behavior.

In some embodiments, the detection system is software installed in an onboard unit (e.g., an electronic control unit (ECU)) of a vehicle having V2X communication capability. The vehicle is a connected vehicle and operates in a roadway environment with N number of remote vehicles that are also connected vehicles, where N is any positive whole number that is sufficient to satisfy a threshold for forming a vehicular micro cloud. The roadway environment may include one or more of the following example elements: an ego vehicle; N remote vehicles; an edge server; and a roadside unit. For the purpose of clarity, the N remote vehicles may be referred to herein as the “remote connected vehicle” or the “remote vehicles” and this will be understood to describe N remote vehicles.

In some embodiments, the detection system includes code and routines stored on and executed by a cloud server or an edge server.

An example of a roadway environment according to some embodiments includes the roadway environment 140 depicted in FIG. 1. As depicted, the roadway environment 140 includes objects. Examples of objects include one or of the following: other automobiles, road surfaces; signs, traffic signals, roadway paint, medians, turns, intersections, animals, pedestrians, debris, potholes, accumulated water, accumulated mud, gravel, roadway construction, cones, bus stops, poles, entrance ramps, exit ramps, breakdown lanes, merging lanes, other lanes, railroad tracks, railroad crossings, and any other tangible object that is present in a roadway environment 140 or otherwise observable or measurable by a camera or some other sensor included in the sensor set.

The ego vehicle and the remote vehicles may be human-driven vehicles, autonomous vehicles, or a combination of human-driven vehicles and autonomous vehicles. In some embodiments, the ego vehicle and the remote vehicles may be equipped with DSRC equipment such as a GPS unit that has lane-level accuracy and a DSRC radio that is capable of transmitting DSRC messages.

In some embodiments, the ego vehicle and some or all of the remote vehicles include their own instance of a detection system. For example, in addition to the ego vehicle, some or all of the remote vehicles include an onboard unit having an instance of the detection system installed therein.

In some embodiments, the ego vehicle and one or more of the remote vehicles are members of a vehicular micro cloud. In some embodiments, the remote vehicles are members of a vehicular micro cloud, but the ego vehicle is not a member of the vehicular micro cloud. In some embodiments, the ego vehicle and some, but not all, of the remote vehicles are members of the vehicular micro cloud. In some embodiments, the ego vehicle and some or all of the remote vehicles are members of the same vehicular macro cloud but not the same vehicular micro cloud, meaning that they are members of various vehicular micro clouds that are all members of the same vehicular macro cloud so that they are still interrelated to one another by the vehicular macro cloud.

An example of a vehicular micro cloud according to some embodiments includes the vehicular micro cloud 194 depicted in FIG. 1. The vehicular micro cloud 194 is depicted in FIG. 1 using a dashed line to indicate that it is an optional feature of the operating environment 100.

Vehicular micro clouds are an optional feature. Some of the embodiments described herein do not include vehicular micro clouds.

Accordingly, in some embodiments multiple instances of the detection system are installed in a group of connected vehicles. In some embodiments, the group of connected vehicles are arranged as a vehicular micro cloud. As described in more detail below, the detection system further organizes the vehicular micro cloud into a set of nano clouds which are each assigned responsibility for completion of a sub-task. Each nano cloud includes at least one member of the vehicular micro cloud so that each nano cloud is operable to complete assigned sub-tasks of a vehicular micro cloud task for the benefit of the members of the vehicular micro cloud.

In some embodiments, a nano cloud includes a subset of a vehicular micro cloud that is organized within the vehicular micro cloud as an entity managed by a hub wherein the entity is organized for the purpose of a completing one or more sub-tasks of a vehicular micro cloud task.

Hub or Hub Vehicle

Hub vehicles are an optional feature of the embodiments described herein. Some of the embodiments described herein include a hub vehicle. Some of the embodiments described herein do not include a hub vehicle.

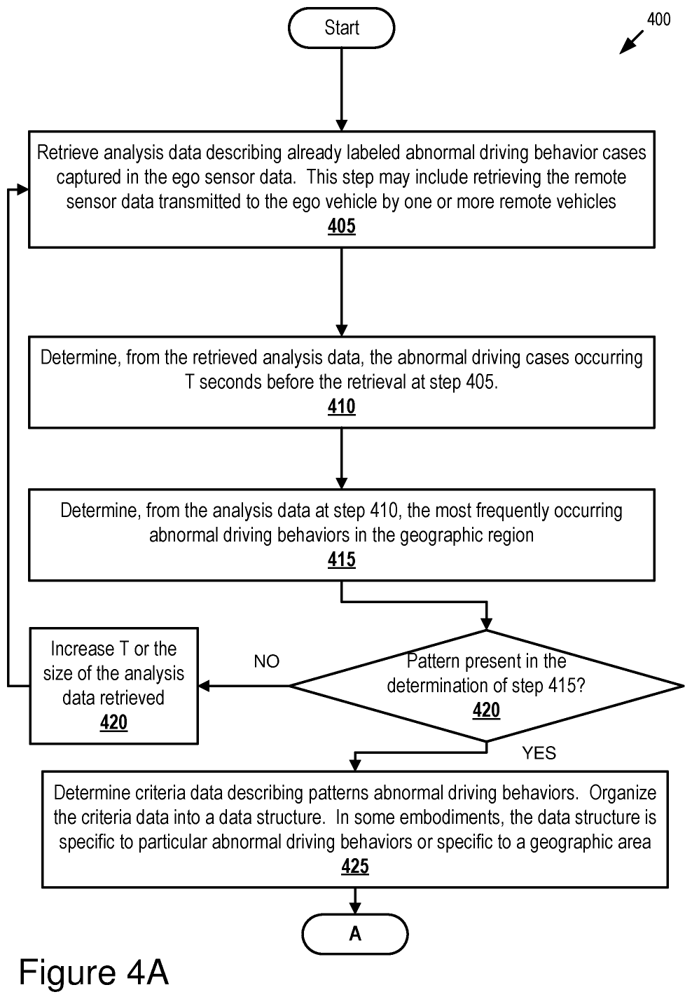

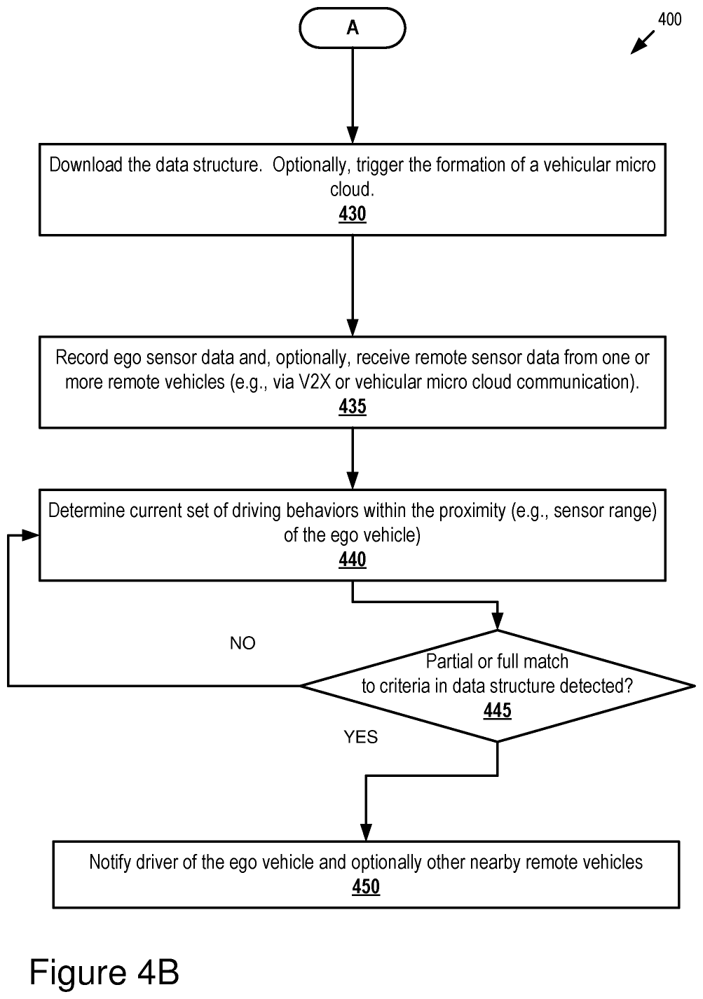

In some embodiments, the detection system that executes a method as described herein (e.g., the method 300 depicted in FIG. 3, the method 400 depicted in FIG. 4, or the example general method described herein, etc.) is an element of a hub or a hub vehicle. For example, the vehicular micro cloud formed by the detection system includes a hub vehicle that provides the following example functionality in addition to the functionality of the methods described herein: (1) controlling when the set of member vehicles leave the vehicular micro cloud (i.e., managing the membership of the vehicular micro cloud, such as who can join, when they can join, when they can leave, etc.); (2) determining how to use the pool of vehicular computing resources to complete a set of tasks in an order for the set of member vehicles wherein the order is determined based on a set of factors that includes safety; (3) determining how to use the pool of vehicular computing resources to complete a set of tasks that do not include any tasks that benefit the hub vehicle; and determining when no more tasks need to be completed, or when no other member vehicles are present except for the hub vehicle, and taking steps to dissolve the vehicular micro cloud responsive to such determinations.

The “hub vehicle” may be referred to herein as the “hub.” An example of a hub vehicle according to some embodiments includes the ego vehicle 123 depicted in FIG. 1. In some embodiments, the operating environment 100 includes a roadside unit or some other roadway device, and this roadway device is the hub of the vehicular micro cloud.

In some embodiments, the detection system determines which member vehicle from a group of vehicles (e.g., the ego vehicle and one or more remote vehicles) will serve as the hub vehicle based on a set of factors that indicate which vehicle (e.g., the ego vehicle or one of the remote vehicles) is the most technologically sophisticated. For example, the member vehicle that has the fastest onboard computer may be the hub vehicle. Other factors that may qualify a vehicle to be the hub include one or more of the following: having the most accurate sensors relative to the other members; having the most bandwidth relative to the other members; and having the most unused memory relative to the other members. Accordingly, the designation of which vehicle is the hub vehicle may be based on a set of factors that includes which vehicle has: (1) the fastest onboard computer relative to the other members; (2) the most accurate sensors relative to the other members; (3) the most bandwidth relative to the other members or other network factors such having radios compliant with the most modern network protocols; and (4) most available memory relative to the other members.

In some embodiments, the designation of which vehicle is the hub vehicle changes over time if the detection system determines that a more technologically sophisticated vehicle joins the vehicular micro cloud. Accordingly, the designation of which vehicle is the hub vehicle is dynamic and not static. In other words, in some embodiments the designation of which vehicle from a group of vehicles is the hub vehicle for that group changes on the fly if a “better” hub vehicle joins the vehicular micro cloud. The factors described in the preceding paragraph are used to determine whether a new vehicle would be better relative to the existing hub vehicle.

In some embodiments, the hub vehicle includes a memory that stores technical data. The technical data includes digital data describing the technological capabilities of each vehicle included in the vehicular micro cloud. The hub vehicle also has access to each vehicle's sensor data because these vehicles broadcast V2X messages that include the sensor data as the payload for the V2X messages. An example of such V2X messages include Basic Safety Messages (BSMs) which include such sensor data in part 2 of their payload. In some embodiments, the technical data is included in the member data (and/or sensor data) depicted in FIG. 1 which vehicles such as the ego vehicle 123 and the remote vehicle 124 broadcast to one another via BSMs. In some embodiments, the member data also includes the sensor data of the vehicle that transmits the BSM as well as some or all of the other digital data described herein as being an element of the member data.

In some embodiments, the technical data is an element of the sensor data (e.g., the ego sensor data or the remote sensor data) which is included in the V2X data.

A vehicle's sensor data is the digital data recorded by that vehicle's onboard sensor set 126. In some embodiments, an ego vehicle's sensor data includes the sensor data recorded by another vehicle's sensor set 126; in these embodiments, the other vehicle transmits the sensor data to the ego vehicle via a V2X communication such as a BSM or some other V2X communication.

In some embodiments, the technical data is an element of the sensor data. In some embodiments, the vehicles distribute their sensor data by transmitting BSMs that includes the sensor data in its payload and this sensor data includes the technical data for each vehicle that transmits a BSM; in this way, the hub vehicle receives the technical data for each of the vehicles included in the vehicular micro cloud.

In some embodiments, the hub vehicle is whichever member vehicle of a vehicular micro cloud has a fastest onboard computer relative to the other member vehicles.

In some embodiments, the detection system is operable to provide its functionality to operating environments and network architectures that do not include a server. Use of servers is problematic in some scenarios because they create latency. For example, some prior art systems require that groups of vehicles relay all their messages to one another through a server. By comparison, the use of server is an optional feature for the detection system. For example, the detection system is an element of a roadside unit that includes a communication unit 145 but not a server. In another example, the detection system is an element of another vehicle such as one of the remote vehicles 124.

In some embodiments, the operating environment of the detection system includes servers. Optionally, in these embodiments the detection system includes code and routines that predict the expected latency of V2X communications involving serves and then time the transmission of these V2X communications so that the latency is minimized or reduced.

In some embodiments, the detection system is operable to provide its functionality even though the vehicle which includes the detection system does not have a Wi-Fi antenna as part of its communication unit. By comparison, some of the existing solutions require the use of a Wi-Fi antenna in order to provide their functionality. Because the detection system does not require a Wi-Fi antenna, it is able to provide its functionality to more vehicles, including older vehicles without Wi-Fi antennas.

In some embodiments, the detection system includes code and routines that, when executed by a processor, cause the processor to control when a member of the vehicular micro cloud may leave or exit the vehicular micro cloud. This approach is beneficial because it means the hub vehicle has certainty about how much computing resources it has at any given time since it controls when vehicles (and their computing resources) may leave the vehicular micro cloud. The existing solutions do not provide this functionality.

In some embodiments, the detection system includes code and routines that, when executed by a processor, cause the processor to designate a particular vehicle to serve as a hub vehicle responsive to determining that the particular vehicle has sufficient unused computing resources and/or trustworthiness to provide micro cloud services to a vehicular micro cloud using the unused computing resources of the particular vehicle. This is beneficial because it guarantees that only those vehicles having something to contribute to the members of the vehicular micro cloud may join the vehicular micro cloud. In some embodiments, vehicles which the detection system determines are ineligible to participate as members of the vehicular micro cloud are also excluded from providing rides to users as part of the Service.

In some embodiments, the detection system manages the vehicular micro cloud so that it is accessible for membership by vehicles which do not have V2V communication capability. This is beneficial because it ensures that legacy vehicles have access to the benefits provided by the vehicular micro cloud. The existing approaches to task completion by a plurality of vehicles do not provide this functionality.

In some embodiments, the detection system is configured so that a particular vehicle (e.g., the ego vehicle) is pre-designated by a vehicle manufacturer to serve as a hub vehicle for any vehicular micro cloud that it joins. The existing approaches to task completion by a plurality of vehicles do not provide this functionality.

The existing solutions generally do not include vehicular micro clouds. Some groups of vehicles (e.g., cliques, platoons, etc.) might appear to be a vehicular micro cloud when they in fact are not a vehicular micro cloud. For example, in some embodiments a vehicular micro cloud requires that all its members share it unused computing resources with the other members of the vehicular micro cloud. Any group of vehicles that does not require all its members to share their unused computing resources with the other members is not a vehicular micro cloud.

In some embodiments, a vehicular micro cloud does not require a server and preferably would not include one because of the latency created by communication with a server. Accordingly, in some but not all embodiments, any group of vehicles that includes a server or whose functionality incorporates a server is not a vehicular micro cloud as this term is used herein.

In some embodiments, a vehicular micro cloud formed by a detection system is operable to harness the unused computing resources of many different vehicles to perform complex computational tasks that a single vehicle alone cannot perform due to the computational limitations of a vehicle's onboard vehicle computer which are known to be limited. Accordingly, any group of vehicles that does harness the unused computing resources of many different vehicles to perform complex computational tasks that a single vehicle alone cannot perform is not a vehicular micro cloud.

In some embodiments, a vehicular micro cloud can include vehicles that are parked, vehicles that are traveling in different directions, infrastructure devices, or almost any endpoint that is within communication range of a member of the vehicular micro cloud.

In some embodiments, the detection system is configured so that vehicles are required to have a predetermined threshold of unused computing resources to become members of a vehicular micro cloud. Accordingly, any group of vehicles that does not require vehicles to have a predetermined threshold of unused computing resources to become members of the group is not a vehicular micro cloud in some embodiments.

In some embodiments, a hub of a vehicular micro cloud is pre-designated by a vehicle manufacturer by the inclusion of one a bit or a token in a memory of the vehicle at the time of manufacture that designates the vehicle as the hub of all vehicular micro clouds which it joins. Accordingly, if a group of vehicles does not include a hub vehicle having a bit or a token in their memory from the time of manufacture that designates it as the hub for all groups of vehicles that it joins, then this group is not a vehicular micro cloud in some embodiments.

A vehicular micro cloud is not a V2X network or a V2V network. For example, neither a V2X network nor a V2V network include a cluster of vehicles in a same geographic region that are computationally joined to one another as members of a logically associated cluster that make available their unused computing resources to the other members of the cluster. In some embodiments, any of the steps of a method described herein (e.g., the method 300 depicted in FIG. 3) is executed by one or more vehicles which are working together collaboratively using V2X communications for the purpose of completing one or more steps of the method(s). By comparison, solutions which only include V2X networks or V2V networks do not necessarily include the ability of two or more vehicles to work together collaboratively to complete one or more steps of a method.

In some embodiments, a vehicular micro cloud includes vehicles that are parked, vehicles that are traveling in different directions, infrastructure devices, or almost any endpoint that is within communication range of a member of the vehicular micro cloud. By comparison, a group of vehicles that exclude such endpoints as a requirement of being a member of the group are not vehicular micro clouds according to some embodiments.

In some embodiments, a vehicular micro cloud is operable to complete computational tasks itself, without delegation of these computational tasks to a cloud server, using the onboard vehicle computers of its members; this is an example of a vehicular micro cloud task according to some embodiments. In some embodiments, a group of vehicles which relies on a cloud server for its computational analysis, or the difficult parts of its computational analysis, is not a vehicular micro cloud. Although FIG. 1 depicts a server in an operating environment that includes the detection system, the server is an optional feature of the operating environment. An example of a preferred embodiment of the detection system does not include the server in the operating environment which includes the detection system.

In some embodiments, the detection system enables a group of vehicles to perform computationally expensive tasks that could not be completed by any one vehicle in isolation.

An existing solution to vehicular micro cloud task execution involves vehicle platoons. As explained herein, a platoon is not a vehicular micro cloud and does not provide the benefits of a vehicular micro cloud, and some embodiments of the detection system requires vehicular micro cloud; this distinction alone differentiates the detection system from the existing solutions. The detection system is different from the existing solution for additional reasons. For example, the existing solution that relies on vehicle platooning does not include functionality whereby the members of a platoon are changed among the platoons dynamically during the task execution. As another example, the existing solution does not consider the task properties, road geometry, actual and/or predicted traffic information and resource capabilities of vehicles to determine the number of platoons. The existing solution also does not include functionality whereby platoons swap which sub-task they are performing among themselves while the sub-tasks are still being performed by the platoons in parallel. The existing solution also does not include functionality whereby platoons are re-organized based on monitored task executions results/performance and/or available vehicles and resources. As described herein, the detection system includes code and routines that provide, among other things, all of this functionality which is lacking in the existing solution.

Vehicle Control System

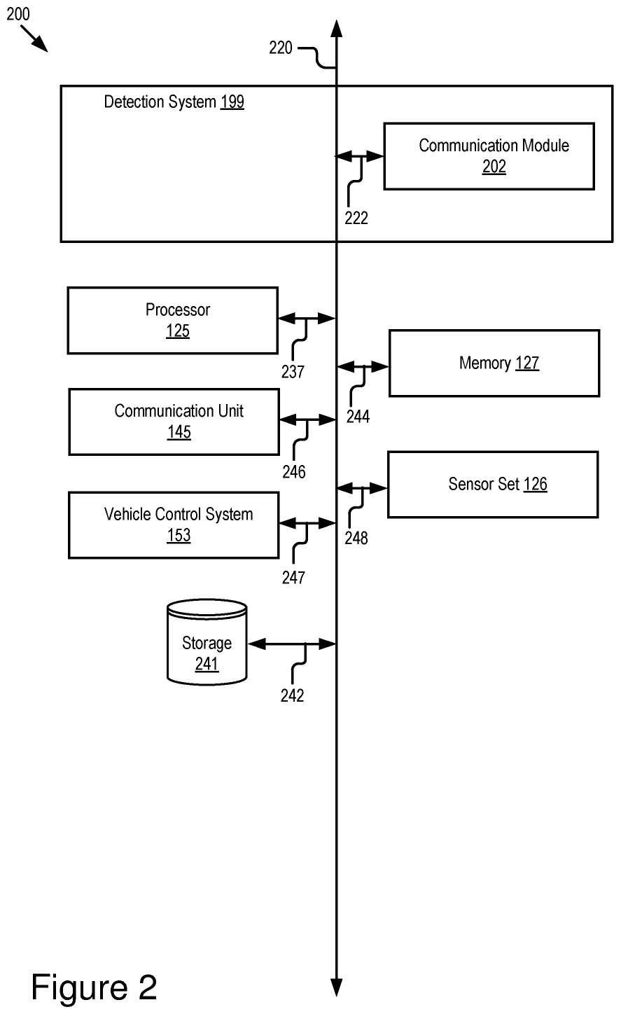

Modern vehicles include Advanced Driver Assistance Systems (ADAS systems) or automated driving systems. These systems are referred to herein collectively or individually as “vehicle control systems.” An automated driving system includes a sufficient number of ADAS systems so that the vehicle which includes these ADAS systems is rendered autonomous by the benefit of the functionality received by the operation of the ADAS systems by a processor of the vehicle. An example of a vehicle control system according to some embodiments includes the vehicle control system 153 depicted in FIGS. 1 and 2.

A particular vehicle that includes these vehicle control systems is referred to herein as an “ego vehicle” and other vehicles in the vicinity of the ego vehicle as “remote vehicles.” As used herein, the term “vehicle” includes a connected vehicle that includes a communication unit and is operable to send and receive V2X communications via a wireless network (e.g., the network 105 depicted in FIG. 1).

Modern vehicles collect a lot of data describing their environment, in particular image data. An ego vehicle uses this image data to understand their environment and operate their vehicle control systems (e.g., ADAS systems or automated driving systems).

As automated vehicles and ADAS systems become increasingly popular, it is important that vehicles have access to the best possible digital data that describes their surrounding environment. In other words, it is important for modern vehicles to have the best possible environmental perception abilities.

Vehicles perceive their surrounding environment by having their onboard sensors record sensor measurements and then analyzing the sensor data to identify one or more of the following: which objects are in their environment; where these objects are located in their environment; and various measurements about these objects (e.g., speed, heading, path history, etc.). This invention is about helping vehicles to have the best possible environmental perception abilities.

Vehicles use their onboard sensors and computing resources to execute perception algorithms that inform them about the objects that are in their environment, where these objects are located in their environment, and various measurements about these objects (e.g., speed, heading, path history, etc.).

Cellular Vehicle to Everything (C-V2X)

C-V2X is an optional feature of the embodiments described herein. Some of the embodiments described herein utilize C-V2X communications. Some of the embodiments described herein do not utilize C-V2X communications. For example, the embodiments described herein utilize V2X communications other than C-V2X communications. C-V2X is defined as 3GPP direct communication (PC5) technologies that include LTE-V2X, 5G NR-V2X, and future 3GPP direct communication technologies.

Dedicated Short-Range Communication (DSRC) is now introduced. A DSRC-equipped device is any processor-based computing device that includes a DSRC transmitter and a DSRC receiver. For example, if a vehicle includes a DSRC transmitter and a DSRC receiver, then the vehicle may be described as “DSRC-enabled” or “DSRC-equipped.” Other types of devices may be DSRC-enabled. For example, one or more of the following devices may be DSRC-equipped: an edge server; a cloud server; a roadside unit (“RSU”); a traffic signal; a traffic light; a vehicle; a smartphone; a smartwatch; a laptop; a tablet computer; a personal computer; and a wearable device.

In some embodiments, instances of the term “DSRC” as used herein may be replaced by the term “C-V2X.” For example, the term “DSRC radio” is replaced by the term “C-V2X radio,” the term “DSRC message” is replaced by the term “C-V2X message,” and so on.

In some embodiments, instances of the term “V2X” as used herein may be replaced by the term “C-V2X.”

In some embodiments, one or more of the connected vehicles described above are DSRC-equipped vehicles. A DSRC-equipped vehicle is a vehicle that includes a standard-compliant GPS unit and a DSRC radio which is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages on a band that is reserved for DSRC messages.

A DSRC message is a wireless message that is specially configured to be sent and received by highly mobile devices such as vehicles, and is compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); and EN 13372:2004 Dedicated Short-Range Communication (DSRC)—DSRC profiles for RTTT applications (review); EN ISO 14906:2004 Electronic Fee Collection—Application interface.

A DSRC message is not any of the following: a WiFi message; a 3G message; a 4G message; an LTE message; a millimeter wave communication message; a Bluetooth message; a satellite communication; and a short-range radio message transmitted or broadcast by a key fob at 315 MHz or 433.92 MHz. For example, in the United States, key fobs for remote keyless systems include a short-range radio transmitter which operates at 315 MHz, and transmissions or broadcasts from this short-range radio transmitter are not DSRC messages since, for example, such transmissions or broadcasts do not comply with any DSRC standard, are not transmitted by a DSRC transmitter of a DSRC radio and are not transmitted at 5.9 GHz. In another example, in Europe and Asia, key fobs for remote keyless systems include a short-range radio transmitter which operates at 433.92 MHz, and transmissions or broadcasts from this short-range radio transmitter are not DSRC messages for similar reasons as those described above for remote keyless systems in the United States.

In some embodiments, a DSRC-equipped device (e.g., a DSRC-equipped vehicle) does not include a conventional global positioning system unit (“GPS unit”), and instead includes a standard-compliant GPS unit. A conventional GPS unit provides positional information that describes a position of the conventional GPS unit with an accuracy of plus or minus 10 meters of the actual position of the conventional GPS unit. By comparison, a standard-compliant GPS unit provides GPS data that describes a position of the standard-compliant GPS unit with an accuracy of plus or minus 1.5 meters of the actual position of the standard-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in even when the roadway has more than one lanes of travel each heading in a same direction.

In some embodiments, a standard-compliant GPS unit is operable to identify, monitor and track its two-dimensional position within 1.5 meters, in all directions, of its actual position 68% of the time under an open sky.

GPS data includes digital data describing the location information outputted by the GPS unit. An example of a standard-compliant GPS unit according to some embodiments includes the standard-compliant GPS unit 150 depicted in FIG. 1.

In some embodiments, the connected vehicle described herein, and depicted in FIG. 1, includes a V2X radio instead of a DSRC radio. In these embodiments, all instances of the term DSRC″ as used in this description may be replaced by the term “V2X.” For example, the term “DSRC radio” is replaced by the term “V2X radio,” the term “DSRC message” is replaced by the term “V2X message,” and so on.

75 MHz of the 5.9 GHz band may be designated for DSRC. However, in some embodiments, the lower 45 MHz of the 5.9 GHz band (specifically, 5.85-5.895 GHz) is reserved by a jurisdiction (e.g., the United States) for unlicensed use (i.e., non-DSRC and non-vehicular related use) whereas the upper 30 MHz of the 5.9 GHz band (specifically, 5.895-5.925 GHz) is reserved by the jurisdiction for Cellular Vehicle to Everything (C-V2X) use. In these embodiments, the V2X radio depicted in FIG. 1 is a C-V2X radio which is operable to send and receive C-V2X wireless messages on the upper 30 MHz of the 5.9 GHz band (i.e., 5.895-5.925 GHz). In these embodiments, the detection system 199 is operable to cooperate with the C-V2X radio and provide its functionality using the content of the C-V2X wireless messages.

In some of these embodiments, some or all of the digital data depicted in FIG. 1 is the payload for one or more C-V2X messages. In some embodiments, the C-V2X message is a BSM.

Vehicular Network

In some embodiments, the detection system utilizes a vehicular network. A vehicular network includes, for example, one or more of the following: V2V; V2X; vehicle-to-network-to-vehicle (V2N2V); vehicle-to-infrastructure (V2I); C-V2X; any derivative or combination of the networks listed herein; and etc.

In some embodiments, the detection system includes software installed in an onboard unit of a connected vehicle. This software is the “detection system” described herein.

An example operating environment for the embodiments described herein includes an ego vehicle, one or more remote vehicles, and a recipient vehicle. The ego vehicle the remote connected vehicle are connected vehicles having communication units that enable them to send and receive wireless messages via one or more vehicular networks. In some embodiments, the recipient vehicle is a connected vehicle. In some embodiments, the ego vehicle and the remote connected vehicle include an onboard unit having a detection system stored therein.

Some of the embodiments described herein include a server. However, some of the embodiments described herein do not include a server. A serverless operating environment is an operating environment which includes at least one detection system and does not include a server.

In some embodiments, the detection system includes code and routines that are operable, when executed by a processor of the onboard unit, to cause the processor to execute one or more of the steps of the method 300 depicted in FIG. 3 or any other method described herein (e.g., the example general method).

This patent application is related to U.S. patent application Ser. No. 15/644,197 filed on Jul. 7, 2017 and entitled “Computation Service for Mobile Nodes in a Roadway Environment,” the entirety of which is hereby incorporated by reference. This patent application is also related to U.S. patent application Ser. No. 16/457,612 filed on Jun. 28, 2019 and entitled “Context System for Providing Cyber Security for Connected Vehicles,” the entirety of which is hereby incorporated by reference.

Example Overview

In some embodiments, the detection system is software that is operable, when executed by a processor, to cause the processor to execute one or more of the methods described herein. An example operating environment 100 for the detection system is depicted in FIG. 1.

In some embodiments, the detection system 199 is software installed in an onboard unit (e.g., an electronic control unit (ECU)) of a particular make of vehicle having V2X communication capability. For example, the ego vehicle 123 includes a communication unit 145. The communication unit 145 includes a V2X radio. For example, the communication unit 145 includes a C-V2X radio. FIG. 1 depicts an example operating environment 100 for the detection system 199 according to some embodiments.

In some embodiments, the remote vehicle 124 is a connected vehicle, which is a vehicle such as the remote vehicle 124 or the ego vehicle 123 having V2X communication capability. In some embodiments, the remote vehicle 124 is not a connected vehicle. The ego vehicle 123 is a connected vehicle.

Example Operative Environment

Embodiments of the detection system are now described. Referring now to FIG. 1, depicted is a block diagram illustrating an operating environment 100 for a detection system 199 according to some embodiments. The operating environment 100 is present in a roadway environment 140. In some embodiments, each of the elements of the operating environment 100 is present in the same roadway environment 140 at the same time. In some embodiments, some of the elements of the operating environment 100 are not present in the same roadway environment 140 at the same time.

The operating environment 100 may include one or more of the following elements: an ego vehicle 123 (referred to herein as a “vehicle 123” or an “ego vehicle 123”) (which has a driver 109 in embodiments where the ego vehicle 123 is not at least a Level III autonomous vehicle); a remote vehicle 124 (which has a driver 108 in embodiments where the remote vehicle 124 is not at least a Level III autonomous vehicle); a cloud server 103; and an edge server 198. These elements are communicatively coupled to one another via a network 105. These elements of the operating environment 100 are depicted by way of illustration. In practice, the operating environment 100 may include one or more of the elements depicted in FIG. 1. For example, although only two vehicles 123, 124 are depicted in FIG. 1, in practice the operating environment 100 can include a plurality of these elements.

The operating environment 100 also includes the roadway environment 140. The roadway environment 140 was described above, and that description will not be repeated here.

In some embodiments, one or more of the ego vehicle 123, the remote vehicle 124, the edge server 198, and the network 105 are elements (e.g., members) of a vehicular micro cloud 194.

In some embodiments, the ego vehicle 123 and the remote vehicle 124 include similar elements. For example, each of these elements of the operating environment 100 include their own processor 125, bus 121, memory 127, communication unit 145, processor 125, sensor set 126, onboard unit 139, standard-compliant GPS unit 150, and detection system 199. These elements of the ego vehicle 123 and the remote vehicle 124 provide the same or similar functionality regardless of whether they are included in the ego vehicle 123 or the remote vehicle 124. Accordingly, the descriptions of these elements will not be repeated in this description for each of the ego vehicle 123 and the remote vehicle 124.

In the depicted embodiment, the ego vehicle 123 and the remote vehicle 124 store similar digital data. The system data 129 includes digital data that describes some or all of the digital data stored in the memory 127 or otherwise described herein. The system data 129 is depicted in FIG. 1 as being an element of the cloud server 103, but in practice the system data 129 is stored on one or more of the cloud server 103, the edge server 198, the ego vehicle 123, and one or more of the remote vehicles 124.

In some embodiments, the vehicular micro cloud 194 is a stationary vehicular micro cloud such as described by U.S. patent application Ser. No. 15/799,964 filed on Oct. 31, 2017 and entitled “Identifying a Geographic Location for a Stationary Micro-Vehicular Cloud,” the entirety of which is herein incorporated by reference. The vehicular micro cloud 194 is depicted with a dashed line in FIG. 1 to indicate that it is an optional element of the operating environment 100.

In some embodiments, the vehicular micro cloud 194 includes a stationary vehicular micro cloud or a mobile vehicular micro cloud. For example, each of the ego vehicle 123 and the remote vehicle 124 are vehicular micro cloud members because they are connected endpoints that are members of the vehicular micro cloud 194 that can access and use the unused computing resources (e.g., their unused processing power, unused data storage, unused sensor capabilities, unused bandwidth, etc.) of the other vehicular micro cloud members using wireless communications that are transmitted via the network 105 and these wireless communicates are not required to be relayed through a cloud server. As used herein, the terms a “vehicular micro cloud” and a “micro-vehicular cloud” mean the same thing.

In some embodiments, the vehicular micro cloud 194 is a vehicular micro cloud such as the one described in U.S. patent application Ser. No. 15/799,963.

In some embodiments, the vehicular micro cloud 194 includes a dynamic vehicular micro cloud. In some embodiments, the vehicular micro cloud 194 includes an interdependent vehicular micro cloud. In some embodiments, the vehicular micro cloud 194 is sub-divided into a set of nano clouds.

In some embodiments, the operating environment 100 includes a plurality of vehicular micro clouds 194. For example, the operating environment 100 includes a first vehicular micro cloud and a second vehicular micro cloud.

In some embodiments, a vehicular micro cloud 194 is not a V2X network or a V2V network because, for example, such networks do not include allowing endpoints of such networks to access and use the unused computing resources of the other endpoints of such networks. By comparison, a vehicular micro cloud 194 requires allowing all members of the vehicular micro cloud 194 to access and use designated unused computing resources of the other members of the vehicular micro cloud 194. In some embodiments, endpoints must satisfy a threshold of unused computing resources in order to join the vehicular micro cloud 194. The hub vehicle of the vehicular micro cloud 194 executes a process to: (1) determine whether endpoints satisfy the threshold as a condition for joining the vehicular micro cloud 194; and (2) determine whether the endpoints that do join the vehicular micro cloud 194 continue to satisfy the threshold after they join as a condition for continuing to be members of the vehicular micro cloud 194.

In some embodiments, a member of the vehicular micro cloud 194 includes any endpoint (e.g., the ego vehicle 123, the remote vehicle 124, the edge server 198, etc.) which has completed a process to join the vehicular micro cloud 194 (e.g., a handshake process with the coordinator of the vehicular micro cloud 194). The cloud server 103 is excluded from membership in the vehicular micro cloud 194 in some embodiments. A member of the vehicular micro cloud 194 is described herein as a “member” or a “micro cloud member.” In some embodiments, a coordinator of the vehicular micro cloud 194 is the hub of the vehicular micro cloud (e.g., the ego vehicle 123).

In some embodiments, the memory 127 of one or more of the endpoints stores member data 171. The member data 171 is digital data that describes one or more of the following: the identity of each of the micro cloud members; what digital data, or bits of data, are stored by each micro cloud member; what computing services are available from each micro cloud member; what computing resources are available from each micro cloud member and what quantity of these resources are available; and how to communicate with each micro cloud member.

In some embodiments, the member data 171 describes logical associations between endpoints which are a necessary component of the vehicular micro cloud 194 and serves to differentiate the vehicular micro cloud 194 from a mere V2X network. In some embodiments, a vehicular micro cloud 194 must include a hub vehicle and this is a further differentiation from a vehicular micro cloud 194 and a V2X network or a group, clique, or platoon of vehicles which is not a vehicular micro cloud 194.

In some embodiments, the member data 171 describes the logical associations between more than one vehicular micro cloud. For example, the member data 171 describes the logical associations between the first vehicular micro cloud and the second vehicular micro cloud. Accordingly, in some embodiments the memory 127 includes member data 171 for more than one vehicular micro cloud 194.

In some embodiments, the vehicular micro cloud 194 does not include a hardware server. Accordingly, in some embodiments the vehicular micro cloud 194 may be described as serverless.

In some embodiments, the vehicular micro cloud 194 includes a hardware server. For example, in some embodiments the vehicular micro cloud 194 includes the cloud server 103.

The network 105 is a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, WiFi (infrastructure mode), WiFi (ad-hoc mode), visible light communication, TV white space communication and satellite communication. The network 105 may also include a mobile data network that may include 3G, 4G, 5G, millimeter wave (mmWave), LTE, LTE-V2X, LTE-D2D, VoLTE or any other mobile data network or combination of mobile data networks. Further, the network 105 may include one or more IEEE 802.11 wireless networks.

In some embodiments, the network 105 is a V2X network. For example, the network 105 must include a vehicle, such as the ego vehicle 123, as an originating endpoint for each wireless communication transmitted by the network 105. An originating endpoint is the endpoint that initiated a wireless communication using the network 105. In some embodiments, the network 105 is a vehicular network. In some embodiments, the network 105 is a C-V2X network.

In some embodiments, the network 105 is an element of the vehicular micro cloud 194. Accordingly, the vehicular micro cloud 194 is not the same thing as the network 105 since the network is merely a component of the vehicular micro cloud 194. For example, the network 105 does not include member data. The network 105 also does not include a hub vehicle.

In some embodiments, one or more of the ego vehicle 123 and the remote vehicle 124 are C-V2X equipped vehicles. For example, the ego vehicle 123 includes a standard-compliant GPS unit 150 that is an element of the sensor set 126 and a C-V2X radio that is an element of the communication unit 145. The network 105 may include a C-V2X communication channel shared among the ego vehicle 123 and a second vehicle such as the remote vehicle 124.

A C-V2X radio is hardware radio that includes a C-V2X receiver and a C-V2X transmitter. The C-V2X radio is operable to wirelessly send and receive C-V2X messages on a band that is reserved for C-V2X messages.

The ego vehicle 123 includes a car, a truck, a sports utility vehicle, a bus, a semi-truck, a drone, or any other roadway-based conveyance. In some embodiments, the ego vehicle 123 includes an autonomous vehicle or a semi-autonomous vehicle. Although not depicted in FIG. 1, in some embodiments, the ego vehicle 123 includes an autonomous driving system. The autonomous driving system includes code and routines that provides sufficient autonomous driving features to the ego vehicle 123 to render the ego vehicle 123 an autonomous vehicle or a highly autonomous vehicle. In some embodiments, the ego vehicle 123 is a Level III autonomous vehicle or higher as defined by the National Highway Traffic Safety Administration and the Society of Automotive Engineers. In some embodiments, the vehicle control system 153 is an autonomous driving system.

The ego vehicle 123 is a connected vehicle. For example, the ego vehicle 123 is communicatively coupled to the network 105 and operable to send and receive messages via the network 105. For example, the ego vehicle 123 transmits and receives V2X messages via the network 105.

The ego vehicle 123 includes one or more of the following elements: a processor 125; a sensor set 126; a standard-compliant GPS unit 150; a vehicle control system 153; a communication unit 145; an onboard unit 139; a memory 127; and a detection system 199. These elements may be communicatively coupled to one another via a bus 121. In some embodiments, the communication unit 145 includes a V2X radio.

The processor 125 includes an arithmetic logic unit, a microprocessor, a general-purpose controller, or some other processor array to perform computations and provide electronic display signals to a display device. The processor 125 processes data signals and may include various computing architectures including a complex instruction set computer (CISC) architecture, a reduced instruction set computer (RISC) architecture, or an architecture implementing a combination of instruction sets. Although FIG. 1 depicts a single processor 125 present in the ego vehicle 123, multiple processors may be included in the ego vehicle 123. The processor 125 may include a graphical processing unit. Other processors, operating systems, sensors, displays, and physical configurations may be possible.

In some embodiments, the processor 125 is an element of a processor-based computing device of the ego vehicle 123. For example, the ego vehicle 123 may include one or more of the following processor-based computing devices and the processor 125 may be an element of one of these devices: an onboard vehicle computer; an electronic control unit; a navigation system; a vehicle control system (e.g., an ADAS system or autonomous driving system); and a head unit. In some embodiments, the processor 125 is an element of the onboard unit 139.

The onboard unit 139 is a special purpose processor-based computing device. In some embodiments, the onboard unit 139 is a communication device that includes one or more of the following elements: the communication unit 145; the processor 125; the memory 127; and the detection system 199. In some embodiments, the onboard unit 139 is the computer system 200 depicted in FIG. 2. In some embodiments, the onboard unit 139 is an electronic control unit (ECU).

The sensor set 126 includes one or more onboard sensors. The sensor set 126 records sensor measurements that describe the ego vehicle 123 and/or the physical environment (e.g., the roadway environment 140) that includes the ego vehicle 123. The ego sensor data 195 includes digital data that describes the sensor measurements.

In some embodiments, the sensor set 126 may include one or more sensors that are operable to measure the physical environment outside of the ego vehicle 123. For example, the sensor set 126 may include cameras, lidar, radar, sonar and other sensors that record one or more physical characteristics of the physical environment that is proximate to the ego vehicle 123.

In some embodiments, the sensor set 126 may include one or more sensors that are operable to measure the physical environment inside a cabin of the ego vehicle 123. For example, the sensor set 126 may record an eye gaze of the driver (e.g., using an internal camera), where the driver's hands are located (e.g., using an internal camera) and whether the driver is touching a head unit or infotainment system with their hands (e.g., using a feedback loop from the head unit or infotainment system that indicates whether the buttons, knobs or screen of these devices is being engaged by the driver).

In some embodiments, the sensor set 126 may include one or more of the following sensors: an altimeter; a gyroscope; a proximity sensor; a microphone; a microphone array; an accelerometer; a camera (internal or external); a LIDAR sensor; a laser altimeter; a navigation sensor (e.g., a global positioning system sensor of the standard-compliant GPS unit 150); an infrared detector; a motion detector; a thermostat; a sound detector, a carbon monoxide sensor; a carbon dioxide sensor; an oxygen sensor; a mass air flow sensor; an engine coolant temperature sensor; a throttle position sensor; a crank shaft position sensor; an automobile engine sensor; a valve timer; an air-fuel ratio meter; a blind spot meter; a curb feeler; a defect detector; a Hall effect sensor, a manifold absolute pressure sensor; a parking sensor; a radar gun; a speedometer; a speed sensor; a tire-pressure monitoring sensor; a torque sensor; a transmission fluid temperature sensor; a turbine speed sensor (TSS); a variable reluctance sensor; a vehicle speed sensor (VSS); a water sensor; a wheel speed sensor; and any other type of automotive sensor.

The sensor set 126 is operable to record ego sensor data 195. The ego sensor data 195 includes digital data that describes images or other measurements of the physical environment such as the conditions, objects, and other vehicles present in the roadway environment. Examples of objects include pedestrians, animals, traffic signs, traffic lights, potholes, etc. Examples of conditions include weather conditions, road surface conditions, shadows, leaf cover on the road surface, any other condition that is measurable by a sensor included in the sensor set 126.

The physical environment may include a roadway region, parking lot, or parking garage that is proximate to the ego vehicle 123. In some embodiments, the roadway environment 140 is a roadway that includes a roadway region. The ego sensor data 195 may describe measurable aspects of the physical environment. In some embodiments, the physical environment is the roadway environment 140. As such, in some embodiments, the roadway environment 140 includes one or more of the following: a roadway region that is proximate to the ego vehicle 123; a parking lot that is proximate to the ego vehicle 123; a parking garage that is proximate to the ego vehicle 123; the conditions present in the physical environment proximate to the ego vehicle 123; the objects present in the physical environment proximate to the ego vehicle 123; and other vehicles present in the physical environment proximate to the ego vehicle 123; any other tangible object that is present in the real-world and proximate to the ego vehicle 123 or otherwise measurable by the sensors of the sensor set 126 or whose presence is determinable from the digital data stored on the memory 127. An item is “proximate to the ego vehicle 123” if it is directly measurable by a sensor of the ego vehicle 123 or its presence is inferable and/or determinable by the detection system 199 based on analysis of the ego sensor data 195 which is recorded by the ego vehicle 123 and/or one or more members of the vehicular micro cloud 194.

In some embodiments, the ego sensor data 195 includes digital data that describes all of the sensor measurements recorded by the sensor set 126 of the ego vehicle.

For example, the ego sensor data 195 includes, among other things, one or more of the following: lidar data (i.e., depth information) recorded by an ego vehicle; or camera data (i.e., image information) recorded by the ego vehicle. The lidar data includes digital data that describes depth information about a roadway environment 140 recorded by a lidar sensor of a sensor set 126 included in the ego vehicle 123. The camera data includes digital data that describes the images recorded by a camera of the sensor set 126 included in the ego vehicle 123. The depth information and the images describe the roadway environment 140, including tangible objects in the roadway environment 140 and any other physical aspects of the roadway environment 140 that are measurable using a depth sensor and/or a camera.

In some embodiments, the sensors of the sensor set 126 are operable to collect ego sensor data 195. The sensors of the sensor set 126 include any sensors that are necessary to measure and record the measurements described by the ego sensor data 195. In some embodiments, the ego sensor data 195 includes any sensor measurements that are necessary to generate the other digital data stored by the memory 127. In some embodiments, the ego sensor data 195 includes digital data that describes any sensor measurements that are necessary for the detection system 199 provides its functionality as described herein with reference to the method 300 depicted in FIG. 3 and/or the example general method described herein.

In some embodiments, the sensor set 126 includes any sensors that are necessary to record ego sensor data 195 that describes the roadway environment 140 in sufficient detail to create a digital twin of the roadway environment 140. In some embodiments, the detection system 199 generates the set of nano clouds and assigns sub-tasks to the nano clouds based on the outcomes observed by the detection system 199 during the execution of a set of digital twins that simulate the real-life circumstances of the ego vehicle 123.

In some embodiments the detection system 199 includes simulation software. The simulation software is any simulation software that is capable of simulating an execution of a vehicular micro cloud task. For example, the simulation software is operable simulate the detection system 199 providing its functionality to generate some or all of the system data 129.

A digital twin is a simulated version of a specific real-world vehicle that exists in a simulation. A structure, condition, behavior, and responses of the digital twin are similar to a structure, condition, behavior, and responses of the specific real-world vehicle that the digital twin represents in the simulation. The digital environment included in the simulation is similar to the real-world roadway environment 140 of the real-world vehicle. The simulation software includes code and routines that are operable to execute simulations based on digital twins of real-world vehicles in the roadway environment.

In some embodiments, the simulation software is integrated with the detection system 199. In some other embodiments, the simulation software is a standalone software that the detection system 199 can access to execute digital twin simulations to determine, for different types of abnormal driving behavior, which set of criteria correspond to the occurrence of the abnormal driving behavior. In this way, the digital twin simulations are used by the detection system 199 in some embodiments to generate the criteria data 132 and build the data structure 131. In some embodiments, the detection system 199 uses the digital twin simulations to determine remedial action plans describing how to respond to the occurrence of different abnormal driving behaviors or combinations of abnormal driving behaviors.

Remedial action plan data includes digital data that describes a strategy for how a driver or group of drivers (e.g., coordinated as a vehicular micro cloud) are recommended by the detection system 199 to respond to the occurrence of an abnormal driving behavior or a combination of abnormal driving behaviors as detected by the detection system 199. An example of the remedial action plan data according to some embodiments includes the remedial action plan data 182 depicted in FIG. 1.

In some embodiments, the detection system 199 causes an electronic display of the ego vehicle 123 to display a message describing a detected abnormal driving behavior and/or a remedial action plan. The message is displayed as an element of a graphical user interface (GUI). GUI data 187 includes digital data that describes the GUI that includes the message. The detection system 199 generates and outputs the GUI data 187.

Digital twin data 162 includes any digital data, software, and/or other information that is necessary to execute the digital twin simulations.

Digital twins, and an example process for generating and using digital twins which is implemented by the detection system 199 in some embodiments, are described in U.S. patent application Ser. No. 16/521,574 entitled “Altering a Vehicle based on Driving Pattern Comparison” filed on Jul. 24, 2019, the entirety of which is hereby incorporated by reference.

The ego sensor data 195 includes digital data that describes any measurement that is taken by one or more of the sensors of the sensor set 126.

The standard-compliant GPS unit 150 includes a GPS unit that is compliant with one or more standards that govern the transmission of V2X wireless communications (“V2X communication” if singular, “V2X communications” if plural). For example, some V2X standards require that BSMs are transmitted at intervals by vehicles and that these BSMs must include within their payload GPS data having one or more attributes.

An example of an attribute for GPS data is accuracy. In some embodiments, the standard-compliant GPS unit 150 is operable to generate GPS measurements which are sufficiently accurate to describe the location of the ego vehicle 123 with lane-level accuracy. Lane-level accuracy is necessary to comply with some of the existing and emerging standards for V2X communication (e.g., C-V2X communication). Lane-level accuracy means that the GPS measurements are sufficiently accurate to describe which lane of a roadway that the ego vehicle 123 is traveling (e.g., the geographic position described by the GPS measurement is accurate to within 1.5 meters of the actual position of the ego vehicle 123 in the real-world). Lane-level accuracy is described in more detail below.

In some embodiments, the standard-compliant GPS unit 150 is compliant with one or more standards governing V2X communications but does not provide GPS measurements that are lane-level accurate.

In some embodiments, the standard-compliant GPS unit 150 includes any hardware and software necessary to make the ego vehicle 123 or the standard-compliant GPS unit 150 compliant with one or more of the following standards governing V2X communications, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); and EN 13372:2004 Dedicated Short-Range Communication (DSRC)—DSRC profiles for RTTT applications (review); EN ISO 14906:2004 Electronic Fee Collection—Application interface.

In some embodiments, the standard-compliant GPS unit 150 is operable to provide GPS data describing the location of the ego vehicle 123 with lane-level accuracy. For example, the ego vehicle 123 is traveling in a lane of a multi-lane roadway. Lane-level accuracy means that the lane of the ego vehicle 123 is described by the GPS data so accurately that a precise lane of travel of the ego vehicle 123 may be accurately determined based on the GPS data for this ego vehicle 123 as provided by the standard-compliant GPS unit 150.

An example process for generating GPS data describing a geographic location of an object (e.g., a vehicle, a roadway object, an object of interest, a remote vehicle 124, the ego vehicle 123, or some other tangible object or construct located in a roadway environment 140) is now described according to some embodiments. In some embodiments, the detection system 199 include code and routines that are operable, when executed by the processor 125, to cause the processor to: analyze (1) GPS data describing the geographic location of the ego vehicle 123 and (2) ego sensor data describing the range separating the ego vehicle 123 from an object and a heading for this range; and determine, based on this analysis, GPS data describing the location of the object. The GPS data describing the location of the object may also have lane-level accuracy because, for example, it is generated using accurate GPS data of the ego vehicle 123 and accurate sensor data describing information about the object.

In some embodiments, the standard-compliant GPS unit 150 includes hardware that wirelessly communicates with a GPS satellite (or GPS server) to retrieve GPS data that describes the geographic location of the ego vehicle 123 with a precision that is compliant with a V2X standard. One example of a V2X standard is the DSRC standard. Other standards governing V2X communications are possible. The DSRC standard requires that GPS data be precise enough to infer if two vehicles (one of which is, for example, the ego vehicle 123) are located in adjacent lanes of travel on a roadway. In some embodiments, the standard-compliant GPS unit 150 is operable to identify, monitor and track its two-dimensional position within 1.5 meters of its actual position 68% of the time under an open sky. Since roadway lanes are typically no less than 3 meters wide, whenever the two-dimensional error of the GPS data is less than 1.5 meters the detection system 199 described herein may analyze the GPS data provided by the standard-compliant GPS unit 150 and determine what lane the ego vehicle 123 is traveling in based on the relative positions of two or more different vehicles (one of which is, for example, the ego vehicle 123) traveling on a roadway at the same time.

By comparison to the standard-compliant GPS unit 150, a conventional GPS unit which is not compliant with the DSRC standard is unable to determine the location of a vehicle (e.g., the ego vehicle 123) with lane-level accuracy. For example, a typical roadway lane is approximately 3 meters wide. However, a conventional GPS unit only has an accuracy of plus or minus 10 meters relative to the actual location of the ego vehicle 123. As a result, such conventional GPS units are not sufficiently accurate to enable the detection system 199 to determine the lane of travel of the ego vehicle 123. This measurement improves the accuracy of the GPS data describing the location of lanes used by the ego vehicle 123 when the detection system 199 is providing its functionality.

In some embodiments, the memory 127 stores two types of GPS data. The first is GPS data of the ego vehicle 123 and the second is GPS data of one or more objects (e.g., the remote vehicle 124 or some other object in the roadway environment). The GPS data of the ego vehicle 123 is digital data that describes a geographic location of the ego vehicle 123. The GPS data of the objects is digital data that describes a geographic location of an object. One or more of these two types of GPS data may have lane-level accuracy.

In some embodiments, one or more of these two types of GPS data are described by the ego sensor data 195. For example, the standard-compliant GPS unit 150 is a sensor included in the sensor set 126 and the GPS data is an example type of ego sensor data 195.

The communication unit 145 transmits and receives data to and from a network 105 or to another communication channel. In some embodiments, the communication unit 145 may include a DSRC transmitter, a DSRC receiver and other hardware or software necessary to make the ego vehicle 123 a DSRC-equipped device. In some embodiments, the detection system 199 is operable to control all or some of the operation of the communication unit 145.

In some embodiments, the communication unit 145 includes a port for direct physical connection to the network 105 or to another communication channel. For example, the communication unit 145 includes a USB, SD, CAT-5, or similar port for wired communication with the network 105. In some embodiments, the communication unit 145 includes a wireless transceiver for exchanging data with the network 105 or other communication channels using one or more wireless communication methods, including: IEEE 802.11; IEEE 802.16, BLUETOOTH®; EN ISO 14906:2004 Electronic Fee Collection—Application interface EN 11253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); the communication method described in U.S. patent application Ser. No. 14/471,387 filed on Aug. 28, 2014 and entitled “Full-Duplex Coordination System”; or another suitable wireless communication method.

In some embodiments, the communication unit 145 includes a radio that is operable to transmit and receive V2X messages via the network 105. For example, the communication unit 145 includes a radio that is operable to transmit and receive any type of V2X communication described above for the network 105.

In some embodiments, the communication unit 145 includes a full-duplex coordination system as described in U.S. Pat. No. 9,369,262 filed on Aug. 28, 2014 and entitled “Full-Duplex Coordination System,” the entirety of which is incorporated herein by reference. In some embodiments, some, or all of the communications necessary to execute the methods described herein are executed using full-duplex wireless communication as described in U.S. Pat. No. 9,369,262.

In some embodiments, the communication unit 145 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some embodiments, the communication unit 145 includes a wired port and a wireless transceiver. The communication unit 145 also provides other conventional connections to the network 105 for distribution of files or media objects using standard network protocols including TCP/IP, HTTP, HTTPS, and SMTP, millimeter wave, DSRC, etc.

In some embodiments, the communication unit 145 includes a V2X radio. The V2X radio is a hardware unit that includes one or more transmitters and one or more receivers that is operable to send and receive any type of V2X message. In some embodiments, the V2X radio is a C-V2X radio that is operable to send and receive C-V2X messages. In some embodiments, the C-V2X radio is operable to send and receive C-V2X messages on the upper 30 MHz of the 5.9 GHz band (i.e., 5.895-5.925 GHz). In some embodiments, some or all of the wireless messages described above with reference to the method 300 depicted in FIG. 3 are transmitted by the C-V2X radio on the upper 30 MHz of the 5.9 GHz band (i.e., 5.895-5.925 GHz) as directed by the detection system 199.

In some embodiments, the V2X radio includes a DSRC transmitter and a DSRC receiver. The DSRC transmitter is operable to transmit and broadcast DSRC messages over the 5.9 GHz band. The DSRC receiver is operable to receive DSRC messages over the 5.9 GHz band. In some embodiments, the DSRC transmitter and the DSRC receiver operate on some other band which is reserved exclusively for DSRC.

In some embodiments, the V2X radio includes a non-transitory memory which stores digital data that controls the frequency for broadcasting BSMs or CPMs. In some embodiments, the non-transitory memory stores a buffered version of the GPS data for the ego vehicle 123 so that the GPS data for the ego vehicle 123 is broadcast as an element of the BSMs or CPMs which are regularly broadcast by the V2X radio (e.g., at an interval of once every 0.10 seconds).

In some embodiments, the V2X radio includes any hardware or software which is necessary to make the ego vehicle 123 compliant with the DSRC standards or any other wireless communication standard that applies to wireless vehicular communications. In some embodiments, the standard-compliant GPS unit 150 is an element of the V2X radio.

The memory 127 may include a non-transitory storage medium. The memory 127 may store instructions or data that may be executed by the processor 125. The instructions or data may include code for performing the techniques described herein. The memory 127 may be a dynamic random-access memory (DRAM) device, a static random-access memory (SRAM) device, flash memory, or some other memory device. In some embodiments, the memory 127 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the memory 127 may store any or all of the digital data or information described herein.

As depicted in FIG. 1, the memory 127 stores the following digital data: the ego sensor data 195; the threshold data 196; the member data 171; the digital twin data 162; the V2X data 133; the GPS data (as an element of the ego sensor data 195); the GUI data 187; the analysis data 181; the remedial action plan data 182; the GUI data 187; the data structure 131; the criteria data 132; the remote sensor data 193; the time data 154; the ego sensor data 195; and the time data 155. The system data 129 includes some or all of this digital data. In some embodiments, the V2X messages (or C-V2X messages or the set of wireless messages) described herein are also stored in the memory 127. The above-described elements of the memory 127 were described above, and so, those descriptions will not be repeated here.

In some embodiments, the ego vehicle 123 includes a vehicle control system 153. A vehicle control system 153 includes one or more ADAS systems or an autonomous driving system. In some embodiments, the detection system 199 uses some or all of the payload of the set of wireless messages described herein as inputs to the vehicle control system 153 to improve the operation of the vehicle control system 153 by increasing the quantity of data it has access to when controlling the operation of the ego vehicle 123.

Examples of an ADAS system include one or more of the following elements of a vehicle: an adaptive cruise control (“ACC”) system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane keep assistance (“LKA”) system; a pedestrian protection system; a traffic sign recognition system; a turning assistant; and a wrong-way driving warning system. Other types of ADAS systems are possible. This list is illustrative and not exclusive.

An ADAS system is an onboard system that is operable to identify one or more factors (e.g., using one or more onboard vehicle sensors) affecting the ego vehicle 123 and modify (or control) the operation of its host vehicle (e.g., the ego vehicle 123) to respond to these identified factors. Described generally, ADAS system functionality includes the process of (1) identifying one or more factors affecting the ego vehicle and (2) modifying the operation of the ego vehicle, or some component of the ego vehicle, based on these identified factors.

For example, an ACC system installed and operational in an ego vehicle may identify that a subject vehicle being followed by the ego vehicle with the cruise control system engaged has increased or decreased its speed. The ACC system may modify the speed of the ego vehicle based on the change in speed of the subject vehicle, and the detection of this change in speed and the modification of the speed of the ego vehicle is an example the ADAS system functionality of the ADAS system.

Similarly, an ego vehicle 123 may have a LKA system installed and operational in an ego vehicle 123 may detect, using one or more external cameras of the ego vehicle 123, an event in which the ego vehicle 123 is near passing a center yellow line which indicates a division of one lane of travel from another lane of travel on a roadway. The LKA system may provide a notification to a driver of the ego vehicle 123 that this event has occurred (e.g., an audible noise or graphical display) or take action to prevent the ego vehicle 123 from actually passing the center yellow line such as making the steering wheel difficult to turn in a direction that would move the ego vehicle over the center yellow line or actually moving the steering wheel so that the ego vehicle 123 is further away from the center yellow line but still safely positioned in its lane of travel. The process of identifying the event and acting responsive to this event is an example of the ADAS system functionality provided by the LKA system.

The other ADAS systems described above each provide their own examples of ADAS system functionalities which are known in the art, and so, these examples of ADAS system functionality will not be repeated here.

In some embodiments, the ADAS system includes any software or hardware included in the vehicle that makes that vehicle be an autonomous vehicle or a semi-autonomous vehicle. In some embodiments, an autonomous driving system is a collection of ADAS systems which provides sufficient ADAS functionality to the ego vehicle 123 to render the ego vehicle 123 an autonomous or semi-autonomous vehicle.

An autonomous driving system includes a set of ADAS systems whose operation render sufficient autonomous functionality to render the ego vehicle 123 an autonomous vehicle (e.g., a Level III autonomous vehicle or higher as defined by the National Highway Traffic Safety Administration and the Society of Automotive Engineers).

In some embodiments, the detection system 199 includes code and routines that are operable, when executed by the processor 125, to execute one or more steps of the example general method described herein. In some embodiments, the detection system 199 includes code and routines that are operable, when executed by the processor 125, to execute one or more steps of the method 300 described below with reference to FIG. 3. In some embodiments, the detection system 199 includes code and routines that are operable, when executed by the processor 125, to execute one or more steps of the method 400 described below with reference to FIGS. 4A and 4B.

An example embodiment of the detection system 199 is depicted in FIG. 2. This embodiment is described in more detail below.

In some embodiments, the detection system 199 is an element of the onboard unit 139 or some other onboard vehicle computer. In some embodiments, the detection system 199 includes code and routines that are stored in the memory 127 and executed by the processor 125 or the onboard unit 139. In some embodiments, the detection system 199 is an element of an onboard unit of the ego vehicle 123 which executes the detection system 199 and controls the operation of the communication unit 145 of the ego vehicle 123 based at least in part on the output from executing the detection system 199.

In some embodiments, the detection system 199 is implemented using hardware including a field-programmable gate array (“FPGA”) or an application-specific integrated circuit (“ASIC”). In some other embodiments, the detection system 199 is implemented using a combination of hardware and software.

The remote vehicle 124 includes elements and functionality which are similar to those described above for the ego vehicle 123, and so, those descriptions will not be repeated here. In some embodiments, one or more of the ego vehicle 123 and the remote vehicle 124 are members of a vehicular micro cloud 194. In some embodiments, the ego vehicle 123 and the remote vehicle 124 are not members of a vehicular micro cloud 194.

The roadway environment 140 is now described according to some embodiments. In some embodiments, some, or all of the ego vehicle 123 and the remote vehicle 124 (or a plurality of remote vehicles) are located in a roadway environment 140. In some embodiments, the roadway environment 140 includes one or more vehicular micro clouds 194. The roadway environment 140 is a portion of the real-world that includes a roadway, the ego vehicle 123 and the remote vehicle 124. The roadway environment 140 may include other elements such as roadway signs, environmental conditions, traffic, etc. The roadway environment 140 includes some or all of the tangible and/or measurable qualities described above with reference to the ego sensor data 195 and the remote sensor data 193. The remote sensor data 193 includes digital data that describes the sensor measurements recorded by the sensor set 126 of the remote vehicle 124.

In some embodiments, the real-world includes the real of human experience comprising physical objects and excludes artificial environments and “virtual” worlds such as computer simulations.

In some embodiments, the roadway environment 140 includes a roadside unit that in includes an edge server 198. In some embodiments, the edge server 198 is a connected processor-based computing device that includes an instance of the detection system 199 and the other elements described above with reference to the ego vehicle 123 (e.g., a processor 125, a memory 127 storing the system data 129, a communication unit 145, etc.). In some embodiments, the roadway device is a member of the vehicular micro cloud 194.

In some embodiments, the edge server 198 includes one or more of the following: a hardware server; a personal computer; a laptop; a device such as a roadside unit; or any other processor-based connected device that is not a member of the vehicular micro cloud 194 and includes an instance of the detection system 199 and a non-transitory memory that stores some or all of the digital data that is stored by the memory 127 of the ego vehicle 123 or otherwise described herein. For example, the memory 127 stores the system data 129. The system data 129 includes some or all of the digital data depicted in FIG. 1 as being stored by the memory 127.

In some embodiments, the edge server 198 includes a backbone network. In some embodiments, the edge server 198 includes an instance of the detection system 199. The functionality of the detection system 199 is described above with reference to the ego vehicle 123, and so, that description will not be repeated here.

In some embodiments, the cloud server 103 one or more of the following: a hardware server; a personal computer; a laptop; a device such as a roadside unit; or any other processor-based connected device that is not a member of the vehicular micro cloud 194 and includes an instance of the detection system 199 and a non-transitory memory that stores some or all of the digital data that is stored by the memory 127 of the ego vehicle 123 or otherwise described herein. For example, the memory 127 stores the system data 129. In some embodiments, the cloud server 103 is operable to enable a detection system 199 of the ego vehicle 123 to provide digital data for a false positive and the detection system of the cloud server 103 is operable to analyze this digital data and determine edits for the criteria data 132 for the type of abnormal driving behavior that resulted in the false positive. For example, the subset of the criteria data 132 that is sufficient to trigger the early detection of the abnormal driving behavior is modified so that future false positives are reduced.

In some embodiments, the cloud server 103 is operable to provide any other functionality described herein. For example, the cloud server 103 is operable to execute some or all of the steps of the methods described herein.

In some embodiments, the cloud server 103 includes an instance of the data structure 131. The data structure 131 includes a non-transitory memory that stores an organized set of digital data. For example, the data structure 131 includes many instances of criteria data that are organized in the data structure 131 and index based on the different types of abnormal driving behaviors. In some embodiments, the data structure 131 is indexed based on geographic location so that a vehicle can upload their GPS data as a query to the data structure 131 and receive a response that includes a subset of the data structure 131 that is tailored to the geographic area associated with the GPS data.

In some embodiments, the vehicular micro cloud 194 is stationary. In other words, in some embodiments the vehicular micro cloud 194 is a “stationary vehicular micro cloud.” A stationary vehicular micro cloud is a wireless network system in which a plurality of connected vehicles (such as the ego vehicle 123, the remote vehicle 124, etc.), and optionally devices such as a roadway device, form a cluster of interconnected vehicles that are located at a same geographic region. These connected vehicles (and, optionally, connected devices) are interconnected via C-V2X, Wi-Fi, mmWave, DSRC or some other form of V2X wireless communication. For example, the connected vehicles are interconnected via a V2X network which may be the network 105 or some other wireless network that is only accessed by the members of the vehicular micro cloud 194 and not non-members such as the cloud server 103. Connected vehicles (and devices such as a roadside unit) which are members of the same stationary vehicular micro cloud make their unused computing resources available to the other members of the stationary vehicular micro cloud.

In some embodiments, the vehicular micro cloud 194 is “stationary” because the geographic location of the vehicular micro cloud 194 is static; different vehicles constantly enter and exit the vehicular micro cloud 194 over time. This means that the computing resources available within the vehicular micro cloud 194 is variable based on the traffic patterns for the geographic location at different times of day: increased traffic corresponds to increased computing resources because more vehicles will be eligible to join the vehicular micro cloud 194; and decreased traffic corresponds to decreased computing resources because less vehicles will be eligible to join the vehicular micro cloud 194.

In some embodiments, the V2X network is a non-infrastructure network. A non-infrastructure network is any conventional wireless network that does not include infrastructure such as cellular towers, servers, or server farms. For example, the V2X network specifically does not include a mobile data network including third generation (3G), fourth generation (4G), fifth generation (5G), long-term evolution (LTE), Voice-over-LTE (VoLTE) or any other mobile data network that relies on infrastructure such as cellular towers, hardware servers or server farms.

In some embodiments, the non-infrastructure network includes Bluetooth® communication networks for sending and receiving data including via one or more of DSRC, mmWave, full-duplex wireless communication and any other type of wireless communication that does not include infrastructure elements. The non-infrastructure network may include vehicle-to-vehicle communication such as a Wi-Fi™ network shared among two or more vehicles 123, 124.

In some embodiments, the wireless messages described herein are encrypted themselves or transmitted via an encrypted communication provided by the network 105. In some embodiments, the network 105 may include an encrypted virtual private network tunnel (“VPN tunnel”) that does not include any infrastructure components such as network towers, hardware servers or server farms. In some embodiments, the detection system 199 includes encryption keys for encrypting wireless messages and decrypting the wireless messages described herein.

Referring now to FIG. 2, depicted is a block diagram illustrating an example computer system 200 including a detection system 199 according to some embodiments.

In some embodiments, the computer system 200 may include a special-purpose computer system that is programmed to perform one or more steps of one or more of the method 300 described herein with reference to FIG. 3 and the example general method described herein.

In some embodiments, the computer system 200 may include a processor-based computing device. For example, the computer system 200 may include an onboard vehicle computer system of the ego vehicle 123 or the remote vehicle 124.

The computer system 200 may include one or more of the following elements according to some examples: the detection system 199; a processor 125; a communication unit 145; a vehicle control system 153; a storage 241; and a memory 127. The components of the computer system 200 are communicatively coupled by a bus 220.

In some embodiments, the computer system 200 includes additional elements such as those depicted in FIG. 1 as elements of the detection system 199.

In the illustrated embodiment, the processor 125 is communicatively coupled to the bus 220 via a signal line 237. The communication unit 145 is communicatively coupled to the bus 220 via a signal line 246. The vehicle control system 153 is communicatively coupled to the bus 220 via a signal line 247. The storage 241 is communicatively coupled to the bus 220 via a signal line 242. The memory 127 is communicatively coupled to the bus 220 via a signal line 244. The sensor set 126 is communicatively coupled to the bus 220 via a signal line 248.

In some embodiments, the sensor set 126 includes standard-compliant GPS unit. In some embodiments, the communication unit 145 includes a sniffer.

The following elements of the computer system 200 were described above with reference to FIG. 1, and so, these descriptions will not be repeated here: the processor 125; the communication unit 145; the vehicle control system 153; the memory 127; and the sensor set 126.

The storage 241 can be a non-transitory storage medium that stores data for providing the functionality described herein. The storage 241 may be a DRAM device, a SRAM device, flash memory, or some other memory devices. In some embodiments, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the detection system 199 includes code and routines that are operable, when executed by the processor 125, to cause the processor 125 to execute one or more steps of the method 300 described herein with reference to FIG. 3. In some embodiments, the detection system 199 includes code and routines that are operable, when executed by the processor 125, to cause the processor 125 to execute one or more steps of the method 400 described herein with reference to FIGS. 4A and 4B. In some embodiments, the detection system 199 includes code and routines that are operable, when executed by the processor 125, to cause the processor 125 to execute one or more steps of the example general method.

In the illustrated embodiment shown in FIG. 2, the detection system 199 includes a communication module 202.

The communication module 202 can be software including routines for handling communications between the detection system 199 and other components of the computer system 200. In some embodiments, the communication module 202 can be a set of instructions executable by the processor 125 to provide the functionality described below for handling communications between the detection system 199 and other components of the computer system 200. In some embodiments, the communication module 202 can be stored in the memory 127 of the computer system 200 and can be accessible and executable by the processor 125. The communication module 202 may be adapted for cooperation and communication with the processor 125 and other components of the computer system 200 via signal line 222.

The communication module 202 sends and receives data, via the communication unit 145, to and from one or more elements of the operating environment 100.

In some embodiments, the communication module 202 receives data from components of the detection system 199 and stores the data in one or more of the storage 241 and the memory 127.

In some embodiments, the communication module 202 may handle communications between components of the detection system 199 or the computer system 200.

Referring now to FIGS. 3, depicted is a flowchart of an example method 300 according to some embodiments. The method 300 includes step 305, step 310, step 315, and step 320 as depicted in FIG. 3. The steps of the method 300 may be executed in any order, and not necessarily those depicted in FIG. 3. In some embodiments, one or more of the steps are skipped or modified in ways that are described herein or known or otherwise determinable by those having ordinary skill in the art.

Referring now to FIGS. 4A and 4B, depicted is a flowchart of an example method 400 according to some embodiments. The method 400 includes step 405, step 410, step 415, step 420, step 425, step 430, step 435, step 440, step 445, and step 450 as depicted in FIGS. 4A and 4B. The steps of the method 400 may be executed in any order, and not necessarily those depicted in FIGS. 4A and 4B. In some embodiments, one or more of the steps are skipped or modified in ways that are described herein or known or otherwise determinable by those having ordinary skill in the art.

Example differences in technical effect between the methods 300, 400 and the prior art are described below. These examples are illustrative and not exhaustive of the possible differences.

The existing solutions do not utilize vehicular micro clouds to implement a Service. The existing solutions also do not use digital twin simulations or other methods described herein to determine origin data and or selected strategy data.

The existing references also do not describe vehicular micro clouds as described herein. Some of the existing solutions require the use of vehicle platooning. A platoon is not a vehicular micro cloud and does not provide the benefits of a vehicular micro cloud, and some embodiments of the detection system that require a vehicular micro cloud. For example, among various differences between a platoon and a vehicular micro cloud, a platoon does not include a hub or a vehicle that provides the functionality of a hub vehicle. By comparison, in some embodiments the detection system includes codes and routines that are operable, when executed by a processor, to cause the processor to utilize vehicular micro clouds to resolve version differences among common vehicle applications installed in different connected vehicles.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A detection system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the detection system to become coupled to other detection systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method executed by an onboard vehicle computer of an ego vehicle, the method comprising:
sensing, by a sensor set of the ego vehicle, a remote vehicle to generate sensor data describing driving behavior of the remote vehicle;
comparing the sensor data to a set of criteria for abnormal driving behavior;
determining that a subset of the set of criteria are described by the sensor data, wherein the subset satisfy a threshold for early detection of abnormal driving behavior; and
determining that the remote vehicle is engaged in abnormal driving behavior based on satisfaction of threshold.

2. The method of claim 1, wherein the subset does not include all of the criteria included in the set of criteria.

3. The method of claim 1, wherein each of the set of criteria are required to be described by the sensor data to avoid false positive detection of abnormal driving behavior and the onboard vehicle computer is configured to determine that the remote vehicle is engaged in abnormal driving behavior responsive to the subset being described by the sensor data so that early detection of abnormal driving behavior is achieved.

4. The method of claim 1, wherein the early detection of abnormal driving behavior includes a risk of false positive detection.

5. The method of claim 1, further comprising executing a remedial action responsive to the abnormal driving behavior.

6. The method of claim 1, further comprising a feedback loop that includes continuing to sense the remote vehicle and determining if the remote vehicle is actually engaged in abnormal driving behavior.

7. The method of claim 6, further comprising determining that the remote vehicle was not engaged in abnormal driving behavior and updating a criteria database with digital data that is configured to reduce a risk of a similar future false positive.

8. The method of claim 1, further comprising receiving a wireless message including digital data describing that the remote vehicle is not engaged in abnormal driving behavior and reversing the determination that the remote vehicle is engaged in abnormal driving behavior.

9. The method of claim 1, wherein the abnormal driving behavior is identified based at least in part on the execution of a set of digital twin simulations.

10. The method of claim 1, wherein at least one step in the method is executed by onboard vehicle computers of one or more vehicles that are members of a vehicular micro cloud.

11. The method of claim 1, wherein the abnormal driving behavior includes a distracted driver behavior and the set of criteria include one or more of the following: (1) a large distance to collision at a first time t₁ followed by a short distance to collision at a second time t₂ that occurs after the first time; and (2) the short distance to collision at the first time t₁ followed by the short distance to collision at the second time t₂ that occurs after the first time.

12. The method of claim 11, wherein the method determines that the remote vehicle is engaged in abnormal driving behavior based on the sensor data describing that the remote vehicle is driving with the large distance to collision and not the short distance to collision.

13. The method of claim 1, wherein the abnormal driving behavior includes an aggressive driver behavior and the set of criteria include (1) multiple attempts to pass a same vehicle, (2) lane cutting, and (3) high speed which satisfies a threshold for speed.

14. The method of claim 13, wherein the method determines that the remote vehicle is engaged in abnormal driving behavior based on the sensor data describing that the remote vehicle is driving with any two of the set of criteria.

15. The method of claim 1, wherein the subset of criteria is included in an ordered list and the method only determines that the remote vehicle is engaged in abnormal driving behavior if the criteria included in the subset are sensed by the sensor set occurring in the order of the list.

16. The method of claim 1, wherein the subset of criteria is included in a list and the method determines that the remote vehicle is engaged in abnormal driving behavior if the criteria included in the subset are sensed by the sensor set occurring in any order.

17. The method of claim 1, wherein the subset is variable based on a geographic location of the remote vehicle.

18. The method of claim 1, wherein an edge server transmits a wireless message to the ego vehicle to specify which subset of criteria correspond to the abnormal driving behavior.

19. A system of an ego vehicle comprising:
a non-transitory memory;
a sensor set;
and a processor communicatively coupled to the non-transitory memory and the sensor set, wherein the non-transitory memory stores computer readable code that is operable, when executed by the processor, to cause the processor to execute steps including:
sensing, by the sensor set, a remote vehicle to generate sensor data describing driving behavior of the remote vehicle;
comparing the sensor data to a set of criteria for abnormal driving behavior;
determining that a subset of the set of criteria are described by the sensor data, wherein the subset satisfy a threshold for early detection of abnormal driving behavior; and
determining that the remote vehicle is engaged in abnormal driving behavior based on satisfaction of threshold.

20. A computer program product including computer code stored on a non-transitory memory that is operable, when executed by an onboard vehicle computer of an ego vehicle, to cause the onboard vehicle computer to execute operations including:
sensing, by a sensor set, a remote vehicle to generate sensor data describing driving behavior of the remote vehicle;
comparing the sensor data to a set of criteria for abnormal driving behavior;
determining that a subset of the set of criteria are described by the sensor data, wherein the subset satisfy a threshold for early detection of abnormal driving behavior; and
determining that the remote vehicle is engaged in abnormal driving behavior based on satisfaction of threshold.
